(19) United States
(12) Patent Application Publication
(10) Pub. No.: US 2005/0240815 A1
(43) Pub. Date: Oct. 27, 2005

(54) Modular imaging of computer software for system install and restore

(75) Inventors: Matthew Purkeypile, San Jose, CA (US); Jeffrey Tay Sulm, Sunnyvale, CA (US); Victor Glen Reha, Mountain View, CA (US); Scott Patton, Morgan Hill, CA (US)

Correspondence Address: CARPENTER & KULAS, LLP, 1900 EMBARCADERO ROAD, SUITE 109, PALO ALTO, CA, 94303, US

(73) Assignees: Sony Corporation; Sony Electronics, Inc.

(21) Appl. No.: 10/823,984

(22) Filed: Apr. 13, 2004

(51) Int. Cl. G06F 11/00

(52) U.S. Cl. 714/15

(57) ABSTRACT

A modular approach to creating a software configuration and to allowing recovery of a configuration. Initial configuration tools can be applied or executed selectively and in different orders at a time of manufacture or shipping of a computer system. Foundation images and modules are stored in a flat directory structure, in one directory, with unique names to make management of, and access to, the images and modules more efficient. Records are used to identify image and module compatibility on specific hardware platforms, or sets (i.e., computer system hardware). In one embodiment a text format is used for the records and other database information to describe and define the images and modules. A hardware set is identified by an identification (ID) code. A recovery set of tools allows a user to selectively restore a system to an original configuration, or to restore selected modules or components. A graphical user interface is described along with facilities for starting and managing a recovery process, application recovery, and Compact Disk (CD)/Digital Video Disk (DVD) media creation from within the computer system's operating system and to recover system and application files and modules; create recovery media and to remind a user to create recovery media.

### BACKGROUND OF THE INVENTION

This invention is related in general to computer systems and more specifically to disk imaging in a computer system to facilitate software installation and recovery.

Today's computer systems, particularly personal computer (PC) systems, are available for purchase with many different software options. A purchaser can typically order a system shipped with an installed base of software that can include different operating systems, application programs, utilities, tools, drivers or other software functionality, referred to as software “components.” The many different choices of software components lead to many thousands or even millions of different combinations of possible software installed configurations or installed software “base.” When a manufacturer or assembler of a computer system allows each customer to order different installed software combinations the approach is called “configure to order” (CTO). In each combination there can be special issues such as hardware configuration needs, additional software that needs to be installed to make other software compatible, libraries or run-time resources that must be included to support software combinations, etc.

Typically, the software configuration requires software components from several different manufacturers. Each manufacturer provides for singular installation of that manufacturer's software component independently of any other software component. For example, a software application such as a word-processing application can be installed by a human user (or automatically or semi-automatically) by loading the application's setup software from a compact disc read-only memory (CDROM) or from another source such as a magnetic disk, via a network, etc.

The single component installation using setup software has the advantage that it can reliably be installed at any time during the life of the computer system. However, the single component installation has drawbacks in that it is a slow process to copy potentially large amounts of information from the media or other source to a hard disk drive in the computer system being configured. Also, single installation often requires obtaining information about the target computer system in order to set configuration parameters, and checking to make sure that other necessary software components are going to be available.

Another type of installation relies on “disk imaging.” Disk imaging is the approach of creating a copy of installed software so that the copy can be directly written to the hard disk of a computer being configured. Assuming that the disk image was properly created for the specific target system to be configured then all of the software components in the disk image should work properly. Disk imaging has the advantage that all configuration steps, additional required software components and other decisions about installation have been incorporated into the disk image so that the installation of the imaged software (which can be all, or a portion of, the required software components) can proceed as a single automated write operation to the target system's hard disk.

Disk imaging is typically used at a time of manufacture, assembly or preparation of a computer system for delivery. One disadvantage with disk imaging is that it is often not possible for an end user to use a disk image to repair or reinstall selected software components from the disk image. This is because the disk image of multiple components is stored as a single file and it is not possible (or is very difficult) to separate out the different components that make up the image. On the other hand, it is cumbersome and confusing for many users to perform single installations of software components as, e.g., from manufacturers' installation media due to the several steps involved and due to the configuration problems that may have to be solved during installation. Restoring from a disk image can also cause user data to be disturbed or destroyed.

### BRIEF SUMMARY OF THE INVENTION

A preferred embodiment of the invention uses a modular approach to creating a software configuration and to allowing recovery of a configuration. A foundation image is used that is substantially common across many systems. Additional software modules can be used to install software that varies often from system-to-system. In one module approach, an automated installer is used to install software from customized “pac” files. In another module approach, an automated setup file procedure can be used to install additional software over the foundation image.

An embodiment of the invention provides tools for modular software configuration at a time of manufacture or initial configuration. Tools can be applied or executed selectively and in different orders. Foundation images and modules are stored in a flat directory structure, in one directory, with unique names to make management of, and access to, the images and modules more efficient. Records are used to identify image and module compatibility on specific hardware platforms, or sets (i.e., computer system hardware). In one embodiment a text format is used for the records and other database information to describe and define the images and modules. A hardware set is identified by an identification (ID) code.

A recovery set of tools allows a user to selectively restore a system to an original configuration, or to restore selected modules or components. A graphical user interface is described along with facilities for starting and managing a recovery process, application recovery, and Compact Disk (CD)/Digital Video Disk (DVD) media creation from within the computer system's operating system and to recover system and application files and modules; create recovery media and to remind a user to create recovery media.

In one embodiment the invention provides a method for configuring a target computer system, the method comprising creating an image of a first plurality of software components; storing the image onto the target computer system; determining additional software components to be stored onto the target computer system; storing the additional software components by using a predefined module.

In another embodiment the invention provides a method for recovering software components, the method comprising installing at least a portion of a foundation image; selectively allowing a user to install a software component from a third-party installation medium; and selectively allowing a user to install a software component from a secondary file.

### BRIEF DESCRIPTION OF THE DRAWINGS

FIG. 1 illustrates the relationships of the different configuration tools to a computer system configuration;

FIG. 2 shows the interaction among the different tools and data;

FIG. 3 shows the interaction of the recovery tools with modular recovery components;

FIG. 4 shows a partition selection graphical user interface within the Launcher tool;

FIG. 5 illustrates basic steps in example recovery procedures;

FIG. 6 illustrates basic steps in possible execution of functions in the Launcher tool;

FIG. 7 shows accessing the Launcher tool from a user interface screen;

FIG. 8 shows accessing Launcher from the Control Panel;

FIG. 9 shows an Introduction Page;

FIG. 10 shows Media and Recovery Options;

FIG. 11 shows a Main Menu screen;

FIG. 12 shows Custom Recovery options;

FIG. 13 shows C and D Drive Sizes;

FIG. 14 shows a Confirmation screen;

FIG. 15 shows a Finish screen;

FIG. 16 shows a Help screen;

FIG. 17 shows an error message from Launcher when P1 is not hidden;

FIG. 18 shows basic steps the user can take as a result of a reminder;

FIG. 19, illustrates a pop-up reminder bubble for recovery;

FIG. 20 illustrates a “right click” menu for a recovery reminder;

FIG. 21 shows the basic processing of PartSeal;

FIG. 22 shows the basic processing for LaunchCombo;

FIG. 23 illustrates the basic steps in processing for Launch Application Recovery;

FIG. 24 shows the basic functionality of System Recovery; and

FIG. 25 illustrates basic aspects of configuration and reconfiguration of a computer system.

### DETAILED DESCRIPTION OF THE INVENTION

Preferred embodiments of the invention are included in a set of software processes called “Pacific Tools” and “Chrysalis Tools”. The Pacific Tools are used in computer system manufacturing and configuration steps performed by Sony Corporation. The preferred embodiment uses object-oriented design and programming techniques. The tools are written in C++ for a Windows operating system and are designed to make use of the Windows Applications Specific Interface (API). Other embodiments can use other computer languages and be adopted for different operating systems. The Chrysalis Tools are provided to a computer system at the time of configuration and can be executed by a user after delivery of the computer system to re-configure software components, or to selectively repair or install different software components.

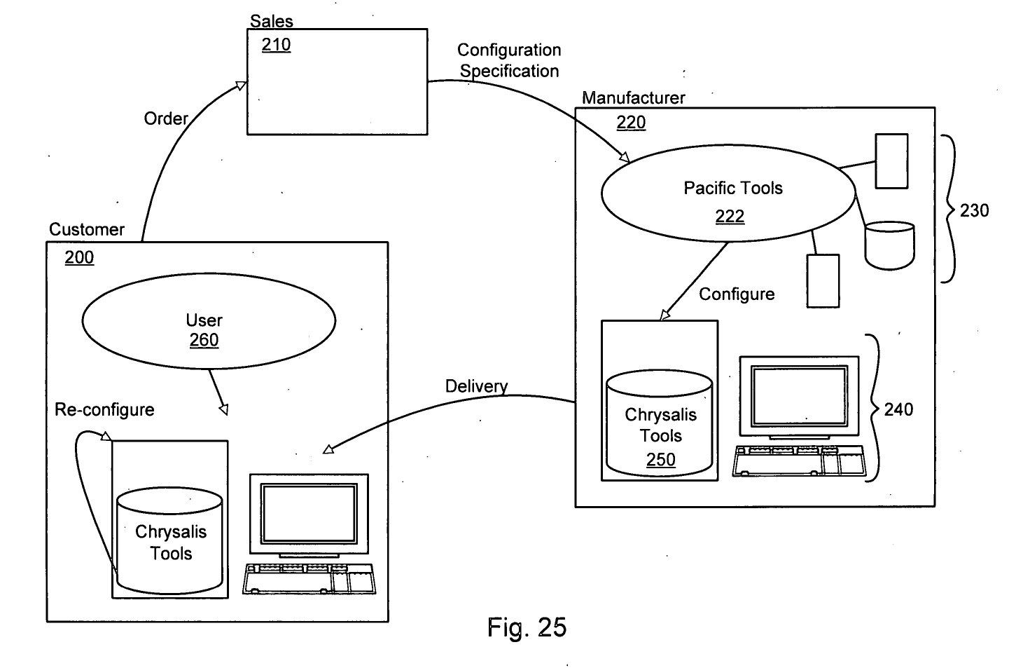

FIG. 25 illustrates basic aspects of configuration and reconfiguration of a computer system according to embodiments of the invention. In FIG. 25, customer 200 places an order with sales department 210. The order is converted into a configuration specification that is transmitted to manufacturer 220. Manufacturer 220 uses Pacific Tools 222 along with resources 230 such as storage, networked processors, etc. to automatically configure computer system 240 to the customer's specifications. Part of the configuration includes storing data and executable software comprising Chrysalis Tools 250 to allow reconfiguration at a later time.

Computer system 240 is shipped to customer 200. At the customer's site, user 260 can use the stored Chrysalis Tools to reconfigure or recover the computer system, or to selectively install or modify different software modules or other components.

When a new computer system is assembled and configured it is loaded with ordered software components. The software components are typically stored in multiple hard disk drive (HDD) partitions. The set of software components on a specific partition is called an image. A typical computer system contains three images: a hidden recovery partition image, the customer C: drive image with the operating system and applications, and a mostly empty D: drive image used for demo multimedia content and end user storage. These three images are the end result of the manufacturing process and the Pacific tools. The images on different computers can vary greatly, even if the hardware on the computers is identical.

In a preferred embodiment, software that is assembled to make an image is considered as either a foundation image or as modules. The foundation image includes the software foundation for a computer; it includes the operating system and any software that is common across all customer options. Certain sets of hardware require different foundation images because the operating system and drivers must be configured specifically for them.

Installing a foundation image to a computer destroys any existing data on the target partition. Since the foundation image wipes out any existing data and contains the operating system, only one foundation image may be installed on any individual computer. Modules include groups of application programs that are bundled up into a single package for automated installation with little or no user intervention. Since a module is a set of applications more than one module may be installed on a computer. However there are some cases where a module may not be available for all computers due to hardware or marketing limitations.

Booting into the foundation image and running the modules installs additional software that may be required for a specific configuration. Once all the desired components are installed, the foundation image is cleaned up and prepared for customer use. One feature of the present invention includes categorizing software components into image and module categories and then using the image and modules to reassemble the desired components. For example in the preferred embodiment there are twenty-seven foundation images and twenty-four modules. With these limited amount of foundation images and modules a total of 452,984,832 possible unique images are available

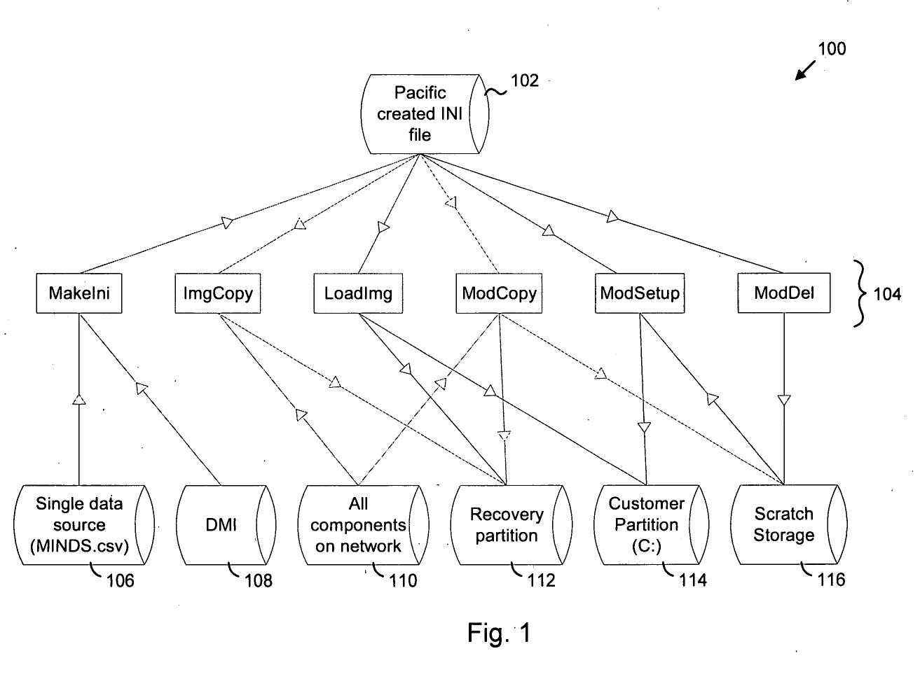

FIG. 1 illustrates the relationships of the different Pacific Tools to a computer system configuration. In a preferred embodiment, six different software processes, or tools, are used. These are shown in FIG. 1 at 104 as MakeIni, ImgCopy, LoadImg, ModCopy, ModSetup and ModDel. Different data sources or repositories (data stores) are shown as 102 and 106 through 116. Arrows from data stores to tools represent an input to the tool, while arrows from tools to data stores are outputs from the tools.

The tools use single data source 106 on a network to determine what components may be installed. This single data source is a database that contains a record of foundation images and modules available for all hardware. An individual record thus precisely identifies either a foundation image or module on a specific set of hardware. There is no ambiguity in what the software is, or to which set of hardware it may install to. Given a set of hardware the list of foundation images and modules that could be installed is a subset of this database. The database is stored in comma separated values (CSV) format. The CSV format is a text file representation of a database where the fields are separated by commas and records are separated by new lines. This CSV database that is used by the Pacific tools is commonly named and referred to as the MINDS.CSV.MINDS is an acronym for modular imaging network download system.

There is also a twenty-four character string in the desktop management interface (DMI) 108 that is called the Mcode. The DMI also contains several other fields that used to identify the hardware set and other computer specific information. The Mcode is divided into three separate subsections. The four most significant characters are alphanumeric and are the product code (Pcode). Each base set of hardware has a unique Pcode. The Pcode value is unique for each hardware set. The next twenty characters are hexadecimal digits. The first eight of these are the hardware Mcode. The final twelve hex characters of the Mcode are called the Software Mcode. The Pcode and software Mcode are used by Pacific to determine what components are to be used. Since the Mcode is contained in the DMI and not on the hard disk, the hard disk may be repartitioned and formatted as needed during manufacturing without affecting the Mcode.

In the preferred embodiment, MakeIni is the first tool that is executed. MakeIni performs a compare against the single CSV and sections of the Computer's DMI that includes the Mcode, model name, and OEM string one, which is internally known as the BIOS lock ID (BLID). The BLID string indicates which Foundation Image is to be used on the system, and is used to prevent the image from being used on a system other then it was shipped on. When this compare is done the exact list of what components are needed for software CTO is obtained. The results are then written to INI file 102 for use by the other Pacific tools, this file typically remains unchanged throughout the use of any of the other Pacific tools. The results of this compare are written to a file instead of obtained by each tool so that there is a record of exactly what components were placed on that system. This file also aids in troubleshooting any problems that arise and forces the list of components to be static from this point on.

LoadImg restores foundation images to a system based on the contents of the MakeIni generated INI file. LoadImg functions as a wrapper around a Blitter program that restores foundation image files to recovery partition 112 or customer partition 114. By acting as a wrapper it can interpret the INI file correctly to pass the desired parameters to the Blitter program. It also traps any errors received from Blitter and handles them if able to do so, or signals a specific error back to the factory process. ImgCopy copies the foundation image files into the hidden recovery partition 112 of the computer to implement hard disk drive recovery for the customer.

There are three tools that handle the installation of modules to a system: ModCopy, ModDel, and ModSetup. ModCopy copies modules down from a network to be stored on the local system. Once the modules are stored locally the modules can be installed more quickly than from the network. ModCopy also copies modules into the hidden recovery partition if needed. ModSetup then installs the modules onto the computer once it is booted into the foundation image. ModSetup uses the Windows API to launch the modules one at a time and trap any possible errors. The final Pacific module tool is ModDel, which cleans up any modules that were copied down using ModCopy. ModDel may use temporary storage 116.

The following paragraphs describe additional details of the tools and data structures in a preferred embodiment. Note that other embodiments can use different design approaches and data formats, as desired.

Structure of the CSV

The CSV format is a way to store a matrix in a text file format. In this format commas separate columns, and new lines separate rows. “Records” in the CSV that correspond to rows in this matrix. “Fields” in the CSV correspond to columns in this matrix.

The CSV is used by Pacific to determine which objects apply to a particular system. This CSV should be the primary (and ideally the only) source of this information. One feature of the preferred embodiment was the use of one data source for all objects that apply to all systems.

The first line of the CSV is the signature line. This is in the format of “Signature=“[signature]. So for example if the signature of the CSV file is “Volubilis 17 Jan. 03 2054” then the first line of the CSV would be “Signature=Volubilis 17 Jan. 03 2054”. This is used to identify when and where the CSV originated.

The second line of the CSV is the name of the fields. The rest of the lines in the CSV are actual records. Record types are listed below in Table I.

TABLE I
“PAC” for PAC files that go on the recovery (P1) image for
application recovery.
“Base Plus Image” for base plus images.
“Recovery Image” for recovery (P1) images.
“PE module” for PE modules. PE modules are like regular
modules, except that they should be run in WinPE and not the image.
This allows for the P1 image to be altered, or the customer image
to be modified before booting into it.
“Data File” for data file modules. The Data File is a module
required by HDD Recovery projects. It is used to add system specific
configuration files to the P1 partition. Like the PE Module, the Data
File module is run in WinPE and not the image. From a technical
standpoint it is identical to the PE Module. However from a
usability standpoint, the PE Module is intended to address a
temporary fix whereas the Data File is always required as an
integral part of the P1 partition.

For the SWMcode field, a string of 12 hex digits is present having one bit on. This string is read from left to right, so if more than one bit is on, then the rest of the bits are ignored. For example if the string “800001000000” is used, it will be treated as “800000000000”. If this entry is longer than 12 digits, only the first 12 are used, and the rest are discarded. If this string is less than 12 hex digits long then trailing zeros are added to it to make it 12 digits long. Thus if a SWMcode entry is “8”, it will be treated as “800000000”.

Table II, below, defines the fields, and their order, in the CSV in a preferred embodiment:

TABLE II

| Column Number | SANE MINDS Format | Pacific Format |
|---|---|---|
| 1 | RecordID | RecordID |
| 2 | ReleaseName | ReleaseName |
| 3 | Project | Project |
| 4 | BaseUnit | BaseUnit |
| 5 | Pcode | Pcode |
| 6 | SITID | SITID |
| 7 | BLID | BLID |
| 8 | Setup | Setup |
| 9 | Version | Version |
| 10 | VersionID | VersionID |
| 11 | Type | Type |
| 12 | BitIndex | BitIndex |
| 13 | SWMcode | SWMcode |
| 14 | Phase | Phase |
| 15 | ServerStatus | ServerStatus |
| 16 | ClientStatus | ClientStatus |
| 17 | User | User |
| 18 | History | Permanent |
| 19 | | History |

In a preferred embodiment, the first line in the csv file begins with “Signature=” followed by a signature string determined by a central control or server. The signature is added to the ini file and the log. If the signature cannot be determined, then “UNKNOWN” is written to the ini file and log.

An example of a CSV file is shown below in Table III:

TABLE III
Signature=Volubilis 1.0.8
DumpOnGTEStatusSortByName(Status=approve-test) 4/9/2003
9:38:00 PM
RecordID,ReleaseName,Project,BaseUnit,Pcode,SITID,BLID,Setup,
Version,VersionID,Type,BitIndex,SWMcode,Phase,ServerStatus,Client
Status,User,Permanent
1775,1 Year Warranty-MOD,Discovery RZP_RXP-HE,PCV-
RZ18G,P025,0222402.SND,N/A,D:\0222402.SND\
WAR10222402.EXE,0222402.SND,
HKEY_LOCAL_MACHINE\SOFTWARE\Sony
Corporation\modules\Warranty\ditis,MODULE,12,000000001000,2,
approve-test,not_used,not in vsms,false
7537,BP-Exodus-HE,Exodus-HE,PCV-RS210,P040,0302801.SND,,\\us-
sj-itd-san-
1\Notebook\v087xeum\build02\0302801.snd\v87x2_0302801.img,
Build02B,c:\windows\system32\oeminfo.ini,Base Plus Image,16672,,-1,
approve-test,not_used,,false
7538,BP-Exodus-HE,Exodus-HE,PCV-RS220,P040,0302801.SND,,\\us-
sj-itd-san-
1\Notebook\v087xeum\build02\0302801.snd\v87x2_0302801.img,
Build02B,c:\windows\system32\oeminfo.ini,Base Plus Image,16672,,-1,
approve-test,not_used,,false
7539,BP-Exodus-HE,Exodus-HE,PCV-RS221,P040,0302801.SND,,\\us-
sj-itd-san-
1\Notebook\v087xeum\build02\0302801.snd\v87x2_0302801.img,
Build02B,c:\windows\system32\oeminfo.ini,Base Plus Image,16672,,-1,
approve-test,not_used,,false
7879,BP-Genesis B2B-PR,Genesis B2B-PR,PCV-
QRS100,P036,0307206.SND,UCV079XEUM,\\us-sj-itd-san-
1\image\v079peum\build01\0307206.snd\v79b1_0307206.img,
Build01S,c:\windows\system32\oeminfo.ini,Monolithic
Image,16672,,1,approve-test,not_used,,false
1632,EPC A-0067-Warranty Fix,Spitfire 2-HE,PCG-
SRX99,462L,0213423.SND,,d:\0213423.SND\EPCA0067.exe,
0213423.SND,HKEY_LOCAL_MACHINE\SOFTWARE\Sony
Corporation\FACUpdates\Warranty HTML,EPC,16672,,-1,approve-
prod,not_used,,false
1639,EPC A-0067-Warranty Fix,Spitfire 2-PR,PCG-
SRX99P,462L,0213423.SND,,d:\0213423.SND\EPCA0067.exe,
0213423.SND,HKEY_LOCAL_MACHINE\SOFTWARE\Sony
Corporation\FACUpdates\Warranty HTML,EPC,16672,,-1,approve-
prod,not_used,,false
1739,EPC A-0067-Warranty Fix,Spitfire 2-PR,PCG-SRX99P
CTO,462L,0213423.SND,,d:\0213423.SND\EPCA0067.exe,
0213423.SND,HKEY_LOCAL_MACHINE\SOFTWARE\Sony
Corporation\FACUpdates\Warranty HTML,EPC,16672,,-1,approve-
prod,not_used,,false

Tools typically have the following properties: they return an error level of zero on success and non-zero on an error. The error code can be looked up in this document to determine the cause of the error. All tools will pass with a blank CSV file or INI file. This is to allow for the tools to be run on a system where they are not used. As a result, the control process (BFS or whatever) would not have to change to accommodate not using these tools. All directory structures are flat. (not nested). The order of the required command line parameters is set and matters. The optional command line parameters always follow the required command line parameters. The order of the optional command line parameters does not matter. If an unknown command line parameter is used, the tool will fail. The first record for any image in the CSV will be the one used. The first record in the CSV that matches for modules, EPCs, PE modules, Data File modules and PAC files that has an SITID that is not already present in the INI file is used. (Later records with the same SITID for that system are ignored). The ordering of items in the INI file does not matter. All tools keep a log file. The match for a foundation image is the only match that is required (unless specified with the command line parameters). Unless otherwise specified, the tools will function successfully with no entries for any other record types. Searches in the CSV and all entries in the INI file are not case sensitive.

The individual Pacific programs MakeIni.exe, LoadImg.exe, ModCopy.exe, ModSetup.exe, ImgCopy.exe and ModDel.exe are independent from each other and do not require other Pacific executables to run. However, in the preferred embodiment a predetermined order requires a configuration INI file specific to the unit to be built first. This data comes from a CSV file for all projects. MakeIni.exe takes this data from the CSV file and produces a model specific INI file. MakeIni.exe must always be run first.

For non-HDD Recovery projects the next two steps are fixed. Run LoadImg.exe is used to restore each partition on the system and then run ModSetup.exe to install any modules. Since ModSetup.exe is intended to install modules within Windows ModSetup.exe must be run after LoadImg.exe.

A required order for non-HDD recovery is as follows: MakeIni.exe (Create MINDS INI file.); ImgCopy.exe (Restore Foundation Image.); and ModSetup.exe (Install modules to Foundation Image).

For HDD Recovery (Pacific) projects there are several scenarios that can be used. In a preferred embodiment a P1 partition is built first. Additional partitions are restored from P1. This scenario is recommended because it potentially saves network bandwidth by building the system from P1. Each unit in turn uses some of its processing power to build itself. Note that step 4 in the following list may be placed after step 2 so that the Foundation Image is restored from some location other than from P1.

Additionally, there is a limitation with Blitter such that a system reboot is needed before the partition type is set correctly. However, when setting a partition to active after blitter'ing with LoadImg.exe and then rebooting, the partition type is often FAT16 instead of NTFS. If the desired partition is instead set to active before blitter'ing with LoadImg.exe this problem does not occur.

A recommended order for building HDD Recovery projects is shown in Table IV:

TABLE IV

| | |
|---|---|
| 1. MakeIni.exe | (Create INI file) |
| 2. ImgCopy.exe | (Copy Recovery Image to temporary location.) |
| 3. LoadImg.exe | (Restore Recovery Image to P1 from |
| | temporary location.) |
| 4. ImgCopy.exe | (Copy Recovery Image to P1 from |
| | temporary location.) |
| 5. ImgCopy.exe | (Copy Foundation Image, etc. to P1 from network.) |
| 6. LoadImg.exe | (Restore Foundation Image to P2.) |
| 7. ModCopy.exe | (Copy permanent modules/EPCs, and PAC files to P1.) |
| 8. ModCopy.exe | (Copy Data File modules to P1.) |
| 9. ModSetup.exe | (Execute Data File modules from P1.) |
| 10. ModCopy.exe | (Copy temporary modules/EPCs to P1.) |
| 11. ModCopy.exe | (Copy PE Modules to P1.) |
| 12. ModSetup.exe | (Execute modules/EPCs.) |
| 13. ModSetup.exe | (Execute PE Modules.) |
| 14. ModDel.exe | (Delete all temporary modules/EPCs from P1.) |
| 15. ModDel.exe | (Delete all temporary Data File modules from P1.) |
| 16. ModDel.exe | (Delete all temporary PE Modules from P1.) |

The following paragraphs explain the format and ordering of Table IV:

1. MakeIni.exe (Create INI file)

Format: MakeIni.exe [Path to INI file to create] [Dir with the CSV files xor a user specified path of a CSV]-failnomod-failnorecovery-failnodfmod

The above command fails if The CSV file does not contain a recovery image, modules/EPCs, or data file modules. Both the Recovery Image and at least one Data File module are required for HDD Recovery projects with the San Diego process

2. ImgCopy.exe (Copy Recovery Image to temporary location.)

Format: ImgCopy.exe [Path to INI file] [Source directory] [Destination directory]-p1

The above command copies the Recovery Image to a temporary location.

3. LoadImg.exe (Restore Recovery Image to P1 from temporary location.)

Format: LoadImg.exe [Path to INI file] [Dir that contains the bitter tools] [Dir that contains the image] 1-xi-recovery-|[Path to log file]

The above command restores the Recovery Image to P1. The Blitter inspect option is used to ensure no errors occurred during the process. Additionally a log is created containing the Blitter diagnostic information.

4. ImgCopy.exe (Copy Recovery Image to P1 from temporary location.)

Format: ImgCopy.exe [Path to INI file] [Source directory] [Destination directory]-p1rcvprt.img

The above command copies the Recovery Image to P1. The Recovery Image is renamed to rcvprt.img. The San Diego factory process requires this image to be renamed.

5. ImgCopy.exe (Copy Foundation Image, etc. to P1 from network.)

Format: ImgCopy.exe [Path to INI file] [Source directory] [Destination directory]-fisony.img

The above command copies the Foundation Image to P1. The Foundation Image is renamed to sony.img. The San Diego factory process requires this image to be renamed.

6. LoadImg.exe (Restore Foundation Image to P2.)

Format: LoadImg.exe [Path to INI file] [Dir that contains the bitter tools] [Dir that contains the image] 2-xi-|[Path to log file]

The above command restores the Foundation Image to P2.

7. ModCopy.exe (Copy permanent modules/EPCs, and PAC files to P1.)

Format: ModCopy.exe [Path to INI file] [Source directory] [Destination directory]-pac-module-permanent

The above command copies all permanent modules/EPCs and PAC files to P1. The-permanent command line parameter is important because at this point no temporary modules should be copied. The Data File module executed with the San Diego process requires only permanent modules on the P1. The temporary modules are copied after executing this Data File module.

8. ModCopy.exe (Copy Data File modules to P1.)

Format: ModCopy.exe [Path to INI file] [Source directory] [Destination directory]-dfmod-temp

The above command copies the temporary Data File modules to P1. The Data File modules are not included in the previous ModCopy.exe command because Data File modules are often temporary.

9. ModSetup.exe (Execute Data File modules from P1.)

Format: ModSetup.exe [Path to INI file] [Permanent module directory] [Temporary module directory]-dodfmod

The above command runs the Data File module. This type of module must be run after P1 is complete. Also, it must be run from P1. Currently with the San Diego process the Data File module is responsible for placing model specific configuration INI files on the P1. An integral tool included with this Data File module is Muir.exe. Muir.exe creates the snyhddrcv.ini file dynamically based on the P1 contents. Muir.exe is deleted after being extracted and executed from the Data File module. The Data File module in turn is deleted along with all temporary modules during the last step, ModDel.exe.

10. ModCopy.exe (Copy temporary modules/EPCs to P1.)

Format: ModCopy.exe [Path to INI file] [Source directory] [Destination directory]-module-temporary

The above command copies all temporary modules to P1.

11. ModCopy.exe (Copy PE Modules to P1.)

Format: ModCopy.exe [Path to INI file] [Source directory] [Destination directory]-pemod

The above command copies all PE Modules to P1.

12. ModSetup.exe (Execute modules/EPCs.)

Format: ModSetup.exe [Path to INI file] [Permanent module directory] [Temporary module directory]

The above command runs all modules. It does not run PE Modules or Data File modules. This command is generally run within the image. The ModSetup.exe source location may be the P1 as at this point P1 contains all available files.

13. ModSetup.exe (Execute PE Modules.)

Format: ModSetup.exe [Path to INI file] [Permanent module directory] [Temporary module directory]-dopemod

The above command runs all PE Modules.

14. ModDel.exe (Delete all temporary modules/EPCs from P1.)

Format: ModDel.exe.\minds_vsms.INI..\pacific_perm

The above command deletes all temporary modules/EPCs. This program must be run after running temporary modules to delete items not intended for the customer.

15. ModDel.exe (Delete all temporary Data File modules from P1.)

Format: ModDel.exe.\minds_vsms.INI..\pacific_perm-deldfmod-failnoexist

The above command deletes all temporary Data File modules. This program must be run after running temporary modules to delete items not intended for the customer.

16. ModDel.exe (Delete all temporary PE Modules from P1.)

Format: ModDel.exe.\minds_vsms.INI..\pacific_perm-delpemod

The above command deletes all temporary PE modules. This program must be run after running temporary modules to delete items not intended for the customer.

MakeIni processes the CSV files. The CSV files are compared against the system's Mcode, Model Name, and BLID in order to create an Ini file called MINDS.INI. This file will contain all the information about the image, base plus image, P1 image for HDD recovery, PE modules, Data File modules, PAC files, modules, and EPCs to use for the system. This first piece is called MakeIni.

This program will fail if no foundation image match is found in the CSV, unless overridden by optional command line parameters. Please note that this program will not fail if no match(es) are found for anything else, unless overridden by optional command line parameters. In addition, this is the only program that reads the DMI information. This is then added to the INI file that is created. The reason for this is so that the other components can be tested (or used) on a system without having to change the DMI.

Two necessary command line arguments are required: the path to the ini file to create, and the location of the CSV (or a directory that contains “minds.csv”). There are also some optional parameters. (Please be aware that the order of the INI file and the CSV has been swapped from the SANE MINDS implementation.) A blank CSV file is acceptable and will return an error code of zero (pass). This is as designed.

There are also several optional parameters. If the optional “-noimage” parameter is used only modules and EPCs will be put in the INI file. If the optional “-blid” parameter is used then the BLID is the only criteria when looking for a match in addition to record type and SW Mcode for modules. This “-blid” switch should not be used in San Diego's process as it will produce unknown results with the Volubilis generated CSV. If the optional “-failnomod” parameter is used then MakeIni will fail if no modules or EPCs are found. If the optional “-failnobp” parameter is used then MakeIni will fail if a base plus image is not found. If the optional “-failnorecovery” parameter is used then MakeIni will fail if no recovery (P1) image is found. If the optional “-failnodfmod” parameter is used then MakeIni will fail if a data file module is not found.

The following shows the format of command line options with optional parameters in italics. When something is in the CSV file or passed exactly as stated then it will be enclosed in quotes.

MakeIni [Path of ini file to create] [Dir with the CSV files
xor a user specified path of a CSV] [“-noimage”] [“-blid”] [“-
failnomod”] [“-failnobp”] [“-failnorecovery”] [“-failnodfmod”]

| | |
|---|---|
| Example: | MakeIni \\mindstest\\databaseoutput a:\minds.ini |
| Example: | MakeIni d:\temp\minds2.ini z:\sj\dboutput\spring02 - |
| | failnobp -failnorecovery -failnodfmod |
| Example: | MakeIni d:\beta1.ini Y:\beta1\test1.csv -blid -noimage |

Process flow (Please note that BLID and record type are the only criteria for a match when the “-blid” parameter is used. Mcode is still used in module matches though):

Check to ensure that the command line is valid

Create a blank INI file. (Clear its contents if it exists.)

Check to see if the CSV is a file that exists. If not, assume it's a dir and look for minds.ini in that dir.

Retrieve the raw 24 byte Mcode, BLID, and Model Name from the system. Strip all trailing spaces from the Model Name, and everything past (and including) the first space.

Determine if the system has an encrypted or plaintext mcode. Read the encrypted Mcode from the system if needed.

Load the CSV file. Remove everything to the right of and including the first space for the “BaseUnit” column. (When checking from left to right)

Dump the signature into the Minds.ini under the section “CSV” and key “Signature”.

Make a note on the screen and in the log if the CSV file is empty (<=2 rows).

Look up the (foundation) Image to use add the image information to Minds.ini. A match is found when the following are the same for the system and the current CSV row: Pcode, BLID, and Model Name (not including “(UC)”). The type of the entry must also be “Foundation Image” or “Monolithic Image”.

Look up the base plus image to use and add the image information to Minds.ini. A match is found when the following are the same for the system and the current CSV row: Pcode, BLID, and Model Name (not including “(UC)”). The type of the entry must also be “base plus”. Fail if one is not found and the “-failnobp” parameter is used.

Look up the recovery image to use and add the image information to Minds.ini. A match is found when the following are the same for the system and the current CSV row: Pcode, and Model Name (not including “(UC)”). The type of the entry must also be “Recovery Image”. Fail if one is not found and the “-failnorecovery” parameter is used. Also as of version 1.1, unless using the “-blid” parameter the BLID will not be checked and is not required to match.

Retrieve the PAC files and add them to the INI file. A match is found when the following criteria is meet between the system and the current CSV row: a PAC file with the same SITID is not already in the INI file, the base units match, the Pcodes match, and the type is “PAC File”.

Retrieve the PE modules and add them to the INI file. A match is found when the following criteria is meet between the system and the current CSV row: a PE module file with the same SITID is not already in the INI file, the base units match, the Pcodes match, and the type is “PE Module”. Please note that SWMcode does not currently apply when searching for PE Modules.

Retrieve the Data File modules and add them to the INI file. A match is found when the following criteria is meet between the system and the current CSV row: a Data File module file with the same SITID is not already in the INI file, the base units match, the Pcodes match, and the type is “Data File”. Please note that SWMcode does not currently apply when searching for Data File modules.

Retrieve the modules to use based on the Mcode, add them to Minds.ini. A match is found when the following criteria is meet between the system and the current CSV row: There is an Mcode match, a module with the same SITID is not already in the image, the base units match, the Pcodes match, and the type is “Module”.

Retrieve EPCs to use based on the Mcode, add them to Minds.ini. Criteria for an EPC match are the same as a module except the SW Mcode is not checked, and the type is “EPC”.

Verify that the ini file has all critical entries present. (For example the SITID entry for a module is present and not blank.)

To read the Mcode the system uses pc_info.dll. This DLL must be the appropriate one (desktop or notebook). In addition the required registry value must exist and point to this DLL. If the DLL and/or registry value are missing or incorrect an error 10 may be returned.

To determine if a system has an encrypted Mcode or not an exclusion list is referenced. MakeIni will look for a file called “ClrMcode.lst” in the same directory as the csv. This file contains a list of BLIDs for systems that have unencrypted Mcodes. If the system is not on that list (or that file does not exist) then the system is assumed to have an encrypted Mcode. If the system has an encrypted Mcode then the files npc_info.dll and dpc_info.dll must exist in the same directory as the csv. These DLLs are used to read the encrypted Mcode from notebook and desktops.

The image for a particular selection will be based on the first model name (not including “(UC)”), Pcode, and BLID match found in the CSV file. The modules will be selected based on a Pcode, SW Mcode, and model name (not including “(UC)”) match. However, modules will not be included if there is already another module with the same SITID in the ini file, or if it is a P-mod. This does not apply when using the “-blid” option.

LoadImg.exe is used to restore a image to a system. It can be run multiple times to restore multiple images. LoadImg.exe works as a wrapper around the Blitter Restorer program—it takes the command line parameters and the ini and constructs arguments to pass to restorer. It also checks to make sure that all parameters are valid. By default it will restore the foundation image to the specified partition. This can be overridden with optional command line parameters.

Load Image has four required arguments: the location of the ini file, the directory that contains the Blitter tools, the directory that contains the image files, and the destination partition on drive 1. There are also optional parameters. If the optional “-bp” parameter is used then the base plus image will be restored instead of the foundation image. If the optional “-recovery” parameter is used then the recovery (P1) image will be restored. If the optional “-xi” parameter is used then restorer's quick inspect (“-xi”) will be used. If the optional “-i”[Filename] parameter is used, then the [Filename] is used as the name of the image file. If the “-|”[Filename] is used then a restorer log is created at [Filename].

LoadImg [location of ini file] [directory that contains the blitter tools]
[directory that contains the image] [partition to restore to, “1”, “2”, etc]
[“-bp”] [“-recovery”] [“-xi”] [“-i”Filename] [“-l”filename]

| | |
|---|---|
| Example: | Loadimg a:\minds.ini \\toolserver\pacific_tools z:\images 2 |
| Example: | Loadimg d:\testfile.ini m:\tools n:\ 1 -xi -recovery |
| Example: | Loadimg u:\inifiles\myfile.ini u:\ z:\ 2 -xi - |
| | iSony.img -lu:\logs\sytem5.log |

Process Flow:
Step 1: Parse and validate the command line parameters.
Step 2: Validate the INI file.
Step 3: Check to make sure all tools are present.
Step 4: Construct the image name to use. (Base Plus and Foundation Image only)
Step 5: Check to make sure the image exists in the specified location.
Step 6: Setup restorer parameters
Step 7: Run restorer and check for an error returned

The image will be looked for in the directory specified on the command line. The image file must be in the following format for foundation images:

[3rd character of BLID][BLID 2 or 3 digit number following the 3rd character]“B”[1 or 2 character phase number]“_”[SITID without the extension]“.img”

So for example if an image has an SITID of 1234567.SND, a Phase of “Build06”, a BLID of “UCV052XEUM”, and the directory specified is “z:\images” then the following image would be loaded: Z:\images\1234567.snd\V52B6_{—}1234567.img

The file name for the recovery (P1) image is obtained from the INI file.

For copying the modules, EPCs, PE modules, Data File modules and PAC files the program ModCopy is used. The modules that are copied are based on the INI file and other command line parameters. The Window's API is used to copy the files. As a result more errors are trappable compared to a batch file or DOS copy command.

There are three required parameters: location of the ini file, source directory, and destination directory. There are also optional parameters, and at least some of them must be used. The first group of optional parameters specifies what to copy. One or more of the following must be used: “-pac” (for PAC files), “-pemod” (for PE modules), “-dfmod” and/or “-module” (for modules and EPCs). The second group of optional parameters is “-permanent” or “-temp” to specify if permanent and/or temporary modules should be copied. If neither of these parameters are used and “-module” and/or “-pemod”, “-dfmod” are used then the program will fail. For PAC files these switches have no effect. In addition there is one other optional parameter, “-s”. If this is used then the module is not overwritten on the destination if it already exists and has the same file size as the source. If “-s” is not used, then the item will always be overwritten if it exists, although this fact will be shown.

ModCopy [location of ini file] [source directory] [destination directory]
[“-pac”] [“-pemod”] [“-dfmod”] [“-module”] [“-permanent]
[“-temp”] [“-s”]

| | |
|---|---|
| Example: | ModCopy a:\test.ini \\anyserver\modules d:\ -module -temp |
| Example: | ModCopy y:\inifiles\minds.ini n:\files f:\permmods - |
| | permanent -module -pemod |
| Example: | ModCopy a:\minds.ini y:\ d:\ -pac -s |

Process Flow:
Step 1: Parse and validate the command line.
Step 2: Validate the INI file.
Step 3: Copy PAC files if specified.
Step 4: Copy the PE modules if specified. (temp and/or permanent)
Step 5: Copy the Data File modules if specified. (temp and/or permanent)
Step 6: Copy the modules and EPCs if specified. (temp and/or permanent)

The items will be copied from [Root module location]+[Filename] to [Copy destination dir]+[Filename]. So if the filename is “testmod.exe” and the root module location is “z:\modules” and the destination dir is \“d:\temp” then this particular module would be copied from “z:\modules\testmod.exe” to “d:\temp\testmod.exe”. The location copying from and to will be displayed and logged in the log.

If a module already exists on the target system that fact will be displayed and logged, and the existing module will be overwritten. (This is the default action that happens when not using “-s”.)

ModSetup.exe is the tool used to install modules, EPCs, and PE modules. The Windows API will be used to launch each installation. This provides several benefits over batch files. One is that more errors can be trapped such as sharing errors, DDE errors, and file association errors. Another advantage is that the next module will not be launched until the previous one has exited. (Based on the process handle.) This is much more reliable than similar methods used in batch files. By default this program will install all modules and EPCs unless told otherwise by optional command line parameters.

There are three required parameters: location of the ini file, location of the permanent modules, and location of the temporary modules. Be aware that the location for the permanent and temporary modules can be the same. There are also some optional parameters. If the optional “-dopemod” parameter is used then PE modules will be installed instead of regular modules (and EPCs). If the options “-dodfmod” parameter is user then Data File modules will be installed instead of regular modules (and EPCs). The “-dopemod” and “-dodfmod” parameters cannot be used together. If the optional “-onlypermanent” parameter is used then only those items marked as permanent will be installed. If the optional “-onlytemp” parameter is used then only those items marked as temporary (“permanent=false” in the INI file) will be installed. The “-onlypermanent” and “-onlytemp” options are exclusive, you can use one or none of them, but not both.

ModSetup [location of ini file] [permanent module directory]
[temporary module directory] [“-dopemod”] [“-dodfmod”] [“-
onlypermanent”] [“-onlytemp”]

| | |
|---|---|
| Example: | ModSetup a:\minds.ini d:\perm d:\temp |
| Example: | ModSetup z:\my.ini n:\n:\ -dopemod |
| Example: | ModSetup y:\inifiles\subdir\test.ini u:\perm z:\temp -onlytemp |
| | -dopemod |

Process Flow:
Step 1: Parse and validate the command line.
Step 2: Validate the INI file.
Step 3: Determine if installing regular modules and EPCs xor PE modules xor Data File modules.
Step 4: Run the items one at a time, checking for errors when doing so

ImgCopy.exe is used to copy images down to the recovery (P1) partition. By default only the foundation image will be copied. However, when using command line parameters only the specified images will be copied. This program will fail if any specified image either does not exist or is not in the INI file. The foundation image is no longer required to copy the recovery image. The foundation image is only required within the INI file when either copying a foundation image or base plus. This program will fail if the specified image (or one of its pieces) already exists in the target location.

The first three command line parameters are: location of the INI file, source directory for the images, and destination directory for the images. There are several optional parameters. For version 1.2.0 and greater the optional “-copyrecovery” parameter is removed. By using the optional parameters “-fi”, “-bp” and/or \“-p1” the foundation image, base plus and/or the recovery partition will be copied respectively. In addition the images can be renamed at the target location by specifying an optional filename next to the image parameter. The “-fi”[Filename] parameter is used then the foundation image will be set to this file name on the target. If the optional “-bp”[Filename] parameter is used then the base plus image will be set to this file name on the target. If the optional “-p1”[Filename] parameter is used then the recovery image will be set to this file name on the target.

ImgCopy [location of ini file] [source directory of images]
[destination dir for images] [“-fi”filename] [“-bp”filename] [“-p1”filename]

| | |
|---|---|
| Example: | ImgCopy x:\minds.ini \\testserver\images m:\ |
| Example: | ImgCopy x:\settings\minds.ini d:\images c:\ -p1 |
| Example: | ImgCopy a:\myfile.ini x:\flatdir z:\systemimages -fiSony |
| | -bpBasePlus -plrcvprt.img |

Process Flow:
Step 1: Parse and validate the command line.
Step 2: Validate the INI file.
Step 3: Construct the file names to use.
Step 4: Copy the files one at a time, checking for errors.

ModDel.exe is used to delete temporary modules. Based on the INI file and the command line parameters the modules are deleted. By default all modules and EPCs that are marked as temporary (“Permanent=false” in the INI File) are deleted.

There are two required command line parameters: the location of the INI file and the directory that contains the temporary modules. There are also two optional command line parameters. The first optional command line parameter is “-delpemod”. If this is used then the temporary PE Modules are deleted. The second optional command line parameter is “-deldfmod”. If this is used then temporary Data File modules are deleted instead. The third optional command line parameter is “-failnoexist” causes ModDel to fail if one of the modules does not exist to delete. Without using this parameter, and specifying the wrong temporary module directory, ModDel.exe will run successfully due to the fact that the modules do not exist in that wrong directory.

ModDel [location of ini file] [directory of the temporary
modules] [“-delpemod”] [“-deldfmod”] [“-failnoexist”]

| | |
|---|---|
| Example: | ModDel a:\minds.ini d:\ |
| Example: | ModDel z:\settings\thisunit.ini m:\tempmods -failnoexist |
| Example: | ModDel c:\thing.ini n:\ -delpemod |

Process Flow:
Step 1: Parse and validate the command line.
Step 2: Validate the INI file.
Step 3: Figure out if deleting modules and EPCs or PE modules or Data File modules.
Step 4: Delete them one at a time. If it does not exist to delete and the “-failnoexist” option is used, fail.

P1Size.exe is used to calculate the size of components. The size of the P1 (recovery) partition depends on the size of the components to be placed in it. P1Size adds up the size of those components, and then writes the size to make P1 to the ini file. Three necessary command line arguments are required: the path to the ini file, the path to the directory that contains the images, and the directory that contains the modules, data file, EPCs, etc. If any of the modules, data file, EPCs, etc are marked as “Permanent=false” then their size will not be included in the total.

There are also several optional parameters. If the “-nofailpac” option is used then the program will not fail if it cannot find the necessary pac files. If the “-nofailpemod” option is used then the program will not fail if it cannot find the PE modules. If the “-nofaildfmod” option is used, the program will not fail if the data file module cannot be found. If the “-nofailmodule” option is used then the program will not fail if modules or EPCs are not found. If the “-nofailimage” option is used then the program will not fail if the required images cannot be found.

MakeIni [Path of ini file] [Image directory] [Module directory]
[“-nofailpac”] [“-nofailpemod”] [“-nofaildfmod”] [“-nofailmodule”]
[“-nofailimage”]

| | |
|---|---|
| Example: | MakeIni a:\minds.ini z:\images y:\dir\modules |
| Example: | MakeIni d:\temp\minds2.ini z:\sj\images\fall03 f:\moduleCD\ |
| | modules -failnoimage |

Process Flow:
Step 1: Verify the command line parameters.
Step 2: Verify the ini file.
Step 3: Get the size of all pac files, data files, pe modules, modules, and EPCs.
Step 4: Get the size of all images (FI and recovery).
Step 5: Calculate size of P1 and write it to the ini file.

The Logging Tool processes create a log run. This log contains the basic operations that are performed by each piece, along with a timestamp. This log is called minds.log and is placed in the same directory as the ini file. The log is appended, not overwritten by each tool. This log contains all output to the screen by each tool except for the program name.

The MakeIni.exe program stores all relevant information about the CSV in an ini file. There are several sections to this CSV file, some which may not exist for some systems. These sections are as follows:

“CSV” which contains the signature of the CSV. This can be used to identify which CSV was used to generate this INI file.

“Image” which contains information about the foundation image. (“foundation image” was not used in order to be backwards compatible with SANE MINDS.) This also stores the BLID, decrypted Mcode, and model name of the system. This means the other tools do not have to read the DMI. More importantly though these entries can be modified in this file to test the tools instead of reflashing the DMI.

“BasePlus” which contains information about the base plus image.

“RecoveryImage” which contains information about the recovery (P1) image.

“PEModule1”, “PEModule2”, . . . , “PEModulen” which contains information about the PE modules.

“File1”, “File2”, . . . , “Filen” which contains information about the Data File modules.

“PAC1”, “PAC2”, . . . , “PACn” which contains information about the PAC files.

“1”, “2”, . . . , “n” which contains information about the modules and EPCs. Be aware that the modules are listed first, followed by the EPCs.

A sample INI file is shown in Table V.
[CSV]
Signature=Volubilis 0.0.0 RC Build10 DumpBackup() 1/16/2003 8:19:48 AM
[Image]
Mcode=P03200000000000400018004
Name=FI-Endeavor RZP-PR
BaseUnit=PCV-RZ20CP
BLID=UCV081PEUM
SITID=0234510.SND
File-\\us-sj-itd-san-
1\desktop\V081PEUM\build01\0234510.SND\v81b1_{—}0234510.img
Phase=1
[BasePlus]
Name=BP-Endeavor RZP-PR
SITID=0000001.snd
File=\\us-sj-itd-san-
1\desktop\V081PEUM\build01\0000001.snd\v81x1_{—}0000001.img
Phase=1
[RecoveryImage]
Name=Generic P1 Image
SITID=0000002.snd
File=\\us-sj-itd-san-
1\desktop\Generic P1\0000002.snd\GP1B1_{—}0000002.img
Phase=1
[PEModule1]
Release_Name=Help Update
   SITID=0000003.snd
Setup=HelpUpdate_{—}0000003.exe
Switches=
Version=
VersionID=
Permanent=false
[File1]
Release_Name=Endeavor PR Data File
SITID=0309425.snd
Setup=ZRDY090309425.EXE
Switches=
Version=
VersionID=
Permanent=false
[PAC1]
Release_Name=Endeavor PR Pac Files
   SITID=0000004.snd
File=Sony_{—}0000004.PAC
[1]
Release_Name=MOD-MPEG
Sitid=0230802.SND
Setup=D:\0230802.SND\MPEG010230802.EXE
Switches=
Version=0230802.SND
VersionID=HKEY_LOCAL_MACHINE\SOFTWARE\Sony
Corporation\Modules\MPEG\ditis
Permanent=true
[2]
Release Name=MOD-RecordNow
Sitid=0234509.SND
Setup=D:\0234509.SND\RDNW040234509.EXE
Switches=
Version=0234509.SND
VersionID=HKEY_LOCAL_MACHINE\Software\Sony
Corporation\Modules\Record Now\ditis
Permanent=false
   TABLE V

Each tool of Pacific will set an error code when exiting. This is designed to pass back information to the factory's process. The error code will be set to zero on success, and non-zero on error. Table VI is a list of error codes in a preferred embodiment.

TABLE VI
Error Codes Table

| | |
|---|---|
| 0 | There was no error, the program ran successfully |
| 1 | The command line is not in the correct format or is missing arguments |
| 2 | Unable to open CSV file for reading |
| 3 | Not enough memory has been allocated to load the csv file - the csv file contains |
| | too many columns. |
| 4 | Not enough memory has been allocated to load the csv file - the csv file contains |
| | too many rows |
| 5 | Unable to expand environment variable |
| 6 | The first command line argument should be a directory and that directory does |
| | not exist. |
| 7 | The second command line argument should be a directory and that directory |
| | does not exist |
| 8 | The second command line argument should be a file and that file does not exist. |
| 9 | The third command line argument should be a file and that file does not exist. |
| 10 | Unable to read Mcode (only on older systems) |
| 11 | Unable to read Mcode via 32-bit code. (Mcode reads “N/A”) |
| 12 | Unable to read from specified ini file |
| 13 | Unable to write to specified ini file |
| 14 | The database csv file does not exist in the specified dir |
| 15 | Unable to read the current process HWND from the system |
| 16 | There is no image for the system BLID/Pcode combination in the database csv. |
| 17 | The database csv file contains too few columns to contain all image |
| | information. |
| 18 | Cmx.dll does not exist in the specified blitter directory. |
| 19 | Blitter.dll does not exist in the specified blitter directory |
| 20 | Blitter.lng does not exist in the specified blitter directory |
| 21 | Restorer.exe does not exist in the specified blitter directory |
| 22 | The entry under “Image” in the specified Ini file is too short to be correct. |
| 23 | An image does not exist |
| 24 | The image restored too fast to be successful. |
| 25 | There was an error copying a module |
| 26 | There was an error executing a module |
| 27 | The root directory specified on the command line is not between A and Z |
| 28 | Unable to create destination directory to copy a module into. |
| 29 | Unable to dynamically allocate memory. (The heap is out of free memory) |
| 30 | A “Release_Name” entry in the ini file is blank for a section. |
| 31 | A “SITID” entry in the ini file is blank for a section. |
| 32 | A “Setup” entry in the ini file is blank for a module. |
| 33 | A “Switches” entry in the ini file is blank for a module. (Not currently used) |
| 34 | A “Version” entry in the ini file is blank for a module. (Not currently used) |
| 35 | A “VersionID” entry in the ini file is blank for a module. (Not currently used) |
| 36 | A “Release_Name” entry does not exist for a section, but there are other entries |
| | for that module. |
| 37 | A “SITID” entry does not exist for a section in the ini file, but there are other |
| | entries for that module. |
| 38 | A “Setup” entry does not exist for a module in the ini file, but there are other |
| | entries for that module. |
| 39 | A “Switches” entry does not exist for a module in the ini file, but there are other |
| | entries for that module. |
| 40 | A “Version” entry does not exist for a module in the ini file, but there are other |
| | entries for that module. |
| 41 | A “VersionID” entry does not exist for a module in the ini file, but there are |
| | other entries for that module. |
| 42 | The Ini file does not exist to verify its contents |
| 43 | Unable to open the output log for writing |
| 44 | Cannot extract a directory from the ini file path specified on the command line. |
| | Make sure a directory was included in the location of the ini file. |
| 45 | Unable to open the Ini file to clear its contents (if it already exits) or to initially |
| | create it. (If it doesn't already exist) |
| 46 | One or more module/epc's have the same file names. (All module/epc names |
| | must be unique.) |
| 47 | The default CSV, Minds.csv, does not exist in the directory specified. |
| 48 | The model name on the system is blank or contains all spaces. |
| 49 | Unable to extract a directory from the CSV location in order to open |
| | ClrMcode.lst |
| 50 | Unable to create or open the regkey |
| | HKEY_LOCAL_MACHINE\software\sony corporation\shared info\shared dlls |
| | for the reading of encrypted Mcodes. |
| 51 | Unable to write the pc_info.dll reg value under |
| | HKEY_LOCAL_MACHINE\software\sony corporation\shared info\shared dlls |
| | to check a desktop encrypted Mcode. |
| 52 | Unable to write the pc_info.dll reg value under |
| | HKEY_LOCAL_MACHINE\software\sony corporation\shared info\shared dlls |
| | to check a notebook encrypted Mcode. |
| 53 | The system should have an encrypted Mcode, but unable to read the encrypted |
| | Mcode after trying both desktop and notebook. Make sure that the system has |
| | an encrypted Mcode and that the Mcode was encrypted with that machines |
| | UUID. |
| 54 | The system should have an encrypted Mcode, but dpc_info.dll does not exist in |
| | the same directory as the csv file. |
| 55 | The system should have an encrypted Mcode, but npc_info.dll does not exist in |
| | the same directory as the csv file. |
| 56 | Unable to write the “Signature” entry to the Ini file in the “CSV” section when |
| | creating the ini file. |
| 57 | Unable to open a file handle to get the file size of a module on the network. (“- |
| | s”was used in ModCopy) |
| 58 | Unable to open a file handle to get the file size of a module on the target |
| | system. (The module does exist and “-s” was used in ModCopy) |
| 59 | Unable to close the file handle to a module on the network. |
| 60 | Unable to close the file handle to a module on the target system. |
| 61 | Unable to successfully start running Restorer.exe due to system error. (Error |
| | could be out of memory, file not found, sharing error, required DLLs not found, etc.) |
| 62 | Restorer encountered an error. (Restorer returned a non zero error code) |
| 63 | A module or EPC had a nonzero return code. |
| 64 | The CSV contains too many fields. (X bound exceeded when loading the CSV) |
| 65 | The CSV cell has already been allocated. (Not NULL) |
| 66 | The directory specified to create the ini file in does not exist. |
| 67 | The second parameter is not a CSV file or is not directory that contains |
| | minds.csv. |
| 68 | An optional command line parameter is invalid or unknown. |
| 69 | The “”-failnomod” option was used and there were no module or EPCs found. |
| 70 | The “-failnobp” option was used and a base plus image was not found in the |
| | CSV for this system. |
| 71 | A section should have a “File” entry in the ini file, but it does not exist. |
| 72 | A section should have a “File” entry in the ini file, but it is blank. |
| 73 | An image should have a “Phase” entry in the ini file, but it does not exist. |
| 74 | An image should have a “Phase” entry in the ini file, but it is blank. |
| 75 | A module should have a “Permanent” entry in the ini file, but it does not exist. |
| 76 | A module should have a “Permanent” entry in the ini file, but it is blank. |
| 77 | The ini file specified does not exist. |
| 78 | The Blitter directory specified does not exist. |
| 79 | The destination partition specified is invalid. (It is less than or equal to zero.) |
| 80 | The specified directory for images does not exist. |
| 81 | The specified source directory does not exist. |
| 82 | The specified destination directory does not exist. |
| 83 | No type was specified. You must specify one or more of the following: “-pac”, |
| | “-pemod”, and/or “-module”. |
| 84 | The permanent directory specified does not exist. |
| 85 | The temp directory specified does not exist. |
| 86 | Both the “-onlypermanent” and “-onlytemp” options were specified. These two |
| | are exclusive-you can use only one or none, but not both. |
| 87 | The target image already exists. |
| 88 | There was an error copying an image file. (Could be out of disk space or |
| | network error) |
| 90 | The “-failnoexist” option was used and the target to delete does not exist. |
| 91 | Unable to clear the attributes of a module to delete it. |
| 92 | There was an error trying to delete a module. |
| 93 | The “-pemod” and/or “-module” parameter was used, but “-temp” and/or |
| | “permanent” was not. PE modules, modules, and EPCs are classified as |
| | temporary or permanent. You must specify which ones (or both) to copy. |
| 94 | The “-failnorecovery” parameter was used and a recovery image was not found |
| | in the CSV for this system. |
| 95 | The “-failnodfmod” parameter was used and a data file module was not found |
| | in the CSV for this system. |
| 96 | The specified module directory does not exist. |
| 97 | The “-nofailpac” option was not used and the pac file did not exist to check to |
| | the size of. |
| 98 | The “-nofailpemod” option was not used and the pe module did not exist to |
| | check to the size of. |
| 99 | The “RecoveryImage” entry under the “File” section of the ini file cannot be |
| | read or does not exist. |

Recovery Tools

A preferred embodiment of the invention uses a set of recovery tools referred to as “Chrysalis”. Chrysalis tools allow end-users, or purchasers, of configured computer systems to restore or reconfigure the computer system after the initial installation of software components. This may be necessary, for example, when a computer system fails or crashes and the software components need to be re-installed, or if a user desires to go back to a previous version or configuration of software, etc. Note that variations are possible from the specific recovery tools described herein. For example, user interface controls and selections can be modified. Some embodiments can use more or less functions or features. The order of application of functions or operations can vary. Additional modifications are possible.

A preferred embodiment of the Chrysalis tools provides five main parts: Launcher, System Recovery, Application Recovery, Create CD, and Reminder. The Chrysalis tools allow a user to configure and organize a custom set of software in a modular fashion.

Chrysalis Launcher is used to start a recovery process for system recovery, application recovery, and Compact Disk (CD)/Digital Video Disk (DVD) media creation from within the computer system's operating system (e.g., Microsoft Windows). System Recovery is used to recover system files. Application Recovery is used to recover applications and modules. Create CD is used to create recovery media such as a recovery CD or DVD. Reminder is used to remind the user to create the Recovery Media.

The Chrysalis tools use a modular approach where components are separated into two types of parts. A first part includes components that are generic, or common, across many platforms and a second part includes components that are specific to a few platforms. The generic components include a P1 Recovery Image and the Chrysalis Tools. The project specific components include a Foundation Image, modules, PAC Files and Data Files.

The P1 Recovery Image includes generic recovery components integral to Chrysalis. This consists of the Chrysalis Tools, WinPE (Windows Pre-installation Environment) operating system and generic help and support files universal across many projects. Software components are stored onto a computer system distributed across three hard disk drive partitions. The first partition is the hidden recovery partition where all the modular components needed by Chrysalis are placed. The second partition is the customer C drive that contains the operating system and applications. The final partition is a mostly empty D drive used for demo multimedia content and end user storage.

The Foundation Image contains the operating system, drivers, and common applications. Since a computer may only run one operating system on a partition, only one Foundation Image may be installed on the C drive. Due to the radically different sets of hardware available on VAIO® computers, Foundation Images are only the same across similar hardware. Hence the Foundation Image may differ between computers—even if they are both notebooks or both desktops.

Modules are applications that are bundled up to install with little or no user intervention. They are independent of Foundation Images and each other allowing them to be interchanged at will. Modules are typically less labor intensive than Foundation Images to build because they package only a small number of files in comparison to Foundation Images.

The customer's C drive is created by first installing a Foundation Image and then any modules selected during CTO. By separating the C drive creation into a process with two types of components the number of configurations that a computer system provider can offer increases exponentially. For example, with just Foundation Image and three modules eight configurations can be offered. A preferred embodiment uses twenty-seven Foundation Images and twenty-four modules to allow a total of 452,984,832 unique possible configurations to be offered to customers.

The PAC File is a compressed, packaged set of files used to restore project-specific applications on the C drive after the Foundation Image is restored. This allows systems with similar hardware to have different basic software sets. Generally a single PAC File is spread over several files so that it can fit on several CDs.

The Data File is a modular executable that contains project-specific configuration files necessary for recovery of applications using PAC Files or modules. It is also used by the Chrysalis program, CreateCD, to create recovery media. Data Files are not used directly within the recovery process for Chrysalis. However, their contents, created when building the build software components are.

In order for a computer system to function as designed the hard disk drive must be configured properly. This configuration includes three partitions: the recovery partition image, the customer C drive image, and the customer D drive image. The recovery partition image is bootable in order to implement recovery. The customer C drive image is bootable in order to be used by the customer. As a result both of these partitions are set as primary partitions. The remaining disk space is allocated to the D drive image, which does not need to be bootable. Thus the D partition is a logical drive on an extended partition.

When a partition is usable by the customer its type is set to NTFS or 0x07—this is the case with the C and D drives. Furthermore the C drive partition is the one booted from by default, so it is marked as active. Only one partition is marked as active at a time. In order to hide the recovery partition from the user the type is set to OEM or 0x12. When a partition is set to type OEM a user in Windows cannot see it. By hiding this partition all but the most advanced users are prevented from altering, or deleting, its contents. As a result the Chrysalis components become hidden from the user while all user content remains visible.

A user is allowed to begin the recovery process of Chrysalis within Windows by using Launcher. This program allows the user to select all of their recovery options from within Windows. However the actual recovery takes place from the hidden recovery partition. To implement this, the recovery partition is unhidden by Launcher by changing the type from OEM to NTFS. The recovery partition is then marked as active so that it is booted on the next boot. The user selections are then written to the recovery partition as a method of passing user selections from Windows into recovery. Afterward a reboot is performed to boot into the recovery partition.

In a preferred embodiment, all necessary components are stored on the recovery partition for hard disk drive recovery. These components include the P1 Recovery Image, the necessary Foundation Image, modules, PAC Files, Data Files, and the Chrysalis Tools themselves. With all of these components recovery is possible, even if the C and D partitions are corrupted or do not exist.

The recovery partition uses WinPE. This scaled down version of Windows XP allows for 32 bit executables to be run and most of the Windows APIs to be used, unlike DOS. In addition it provides for improved disk management via the diskpart tool. WinPE thus allows for a very powerful environment to be used, without the size and clutter of Windows XP or the limitations of DOS.

While booted from the recovery partition the Foundation Image is restored to the C drive in order to install the base set of software and the operating system. In order to completely restore the factory installed software, the modules must be installed as well. To do this the recovery partition is re-hidden and the C drive is set as active. A hook is then placed in the C drive that will launch the module installation. Once module installation is complete this hook is removed and the C drive is completely restored. This technique of installing the C drive Foundation Image from the recovery partition and then setting the hook to install modules is known as combo restore. Without combo restore it would be difficult or impossible to completely recover a customer's C drive to the factory state since the modules would not be installed.

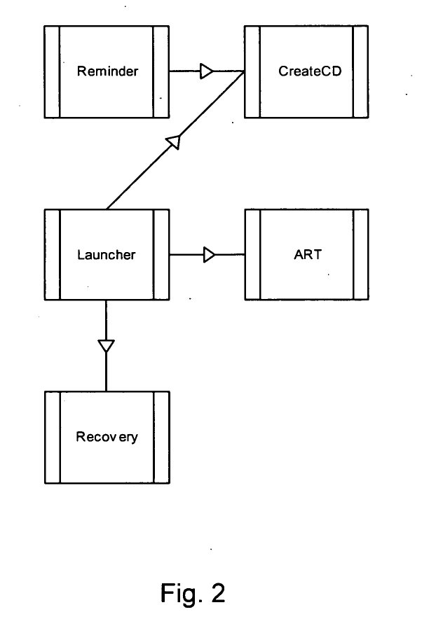

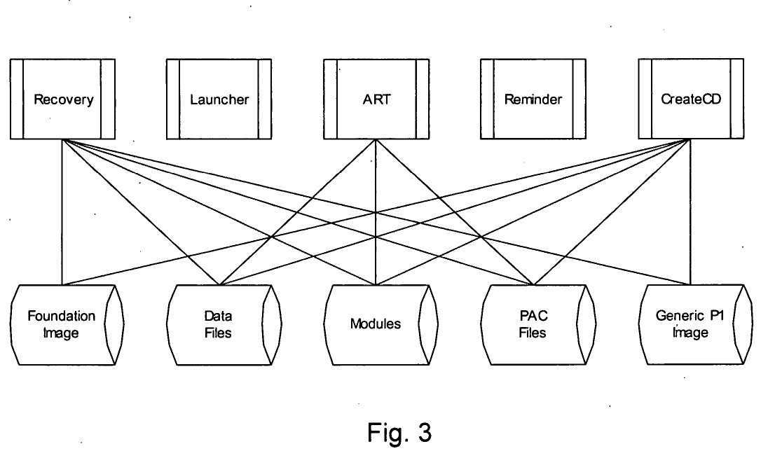

The Chrysalis Tools consist of five main programs: Recovery, Launcher, Art, CreateCD, and Reminder. FIG. 2 shows the interaction among the different programs. FIG. 3 shows the interaction of the Chrysalis Tools with the modular recovery components, some of which can be created, for example, with the Pacific Tools, as discussed above. For example, the recovery module, discussed below, accesses each of the data groups: Foundation Image, Data files, Modules, PAC files and Generic P1 Image.

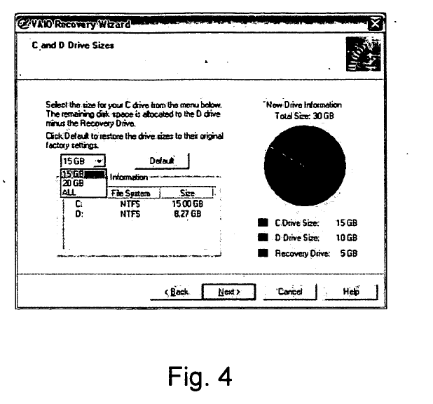

Recovery is designed to run in WinPE to repartition and restore the system. During a basic recovery of the C drive Recovery only restores the Foundation Image. However, Recovery can also be used to re-create the hidden partition. In this case all recovery components are used. Launcher is the starting point within Windows to access the other Chrysalis Tools, namely Recovery, Art and CreateCD. It acts as a wizard to guide the customer to each task. When guiding the user for system recovery, the customer chooses partition sizes and recovery options. This information is placed in an answer file so that Recovery can automatically start the system recovery process without any user interaction. FIG. 4 shows the partition selection GUI within Launcher.

For HDD Recovery the system should have a recovery partition. Otherwise this partition can be restored from a set of CDs/DVDs. The system must have a bootable Windows partition or, through System Recovery, be able to create one. Launcher is installed on the Windows partition. For HDD Recovery, System Recovery and Application Recovery are both installed on the hidden WinPE Recovery Partition. Launcher is used to take user input and launch System Recovery and Application Recovery. System Recovery, to increase single-user and single-computer installation security, is restricted to running in WinPE only. Application Recovery installs programs that require Windows and so is restricted to running in Windows only.

Table VII lists the programs, subprograms, and components of the Chrysalis tools.

TABLE VII

| | |
|---|---|
| AlaunchCombo project | |
| AlaunchCombo.exe | hook program to start combo restore on first |
| | boot. |
| ART project | |
| Art.exe | the executable for Application Recovery. |
| ARStartup project | |
| Arstartup.exe | the executable, which enables/disables P1 and |
| | calls Art.exe |
| Autorun project | |
| Autorun.exe | the executable that runs when a CD is inserted |
| | into a CD drive within WinXP. This program is |
| | included on the CD. |
| Bootswap project | |
| Bootswap.exe | the executable, which loads the recovery wizard |
| | into memory when swapping discs. |
| Launcher project | |
| VAIO Recovery | the executable presenting a main menu in |
| Wizard.exe | which Application Recovery, System Recovery |
| | and CreateCD are available. |
| ENG_PDR_HDR | |
| project | |
| Resource.dll | the component, which allows for an |
| | international version of Recovery.exe. This |
| | component is required by Recovery.exe |
| CreateCD project | |
| Createcd.exe | the executable responsible for creating a |
| | Recovery Startup CD. This program uses |
| | PrimoSDK to record. |
| Rcvfile project | |
| Rcvfile.dll | the component which copies files from one |
| | location to P1. This is used by SRCDs for |
| | recovering P1. |
| Reboot project | |
| Reboot.exe | the component which is responsible for |
| | rebooting the system during Application |
| | Recovery |
| Recovery project | |
| Recovery.exe | the executable responsible for System Recovery. |
| RemovePageFile | |
| project | |
| RemovePageFile.exe | the executable responsible for removing the |
| | Windows pagefile.sys file and System Volume |
| | Information directory from the D drive. |
| Rstartlib project | |
| Rstartlib.lib | the component which does Pone's functionality. |
| | This program is no longer used as a .lib file. |
| | Pone functionality is sped up by three or more |
| | times when the Rstartlib source code is placed |
| | directly into the calling project sources. |

Launcher includes the following functionality: GUI Wizard allowing C Drive Recovery; GUI Wizard allowing System Restore that launches Windows System Restore and exits Launcher; GUI Wizard allowing Full Recovery; GUI Wizard allowing basic System files and drivers Recovery—this saves user input for Base Plus Recovery. The user is given the option to repartition the hard disk. Note that this repartitioning does not include the Recovery Partition.

Launcher also includes an Answer File that saves user GUI input to a file on Recovery Partition. The Answer File is readable from System Recovery.

Create Recovery Media is designed to work with CreateCD and the recording software tools Px.dll, PrimoSDK.dll from Veritas. Other embodiments can use any suitable recording tools.

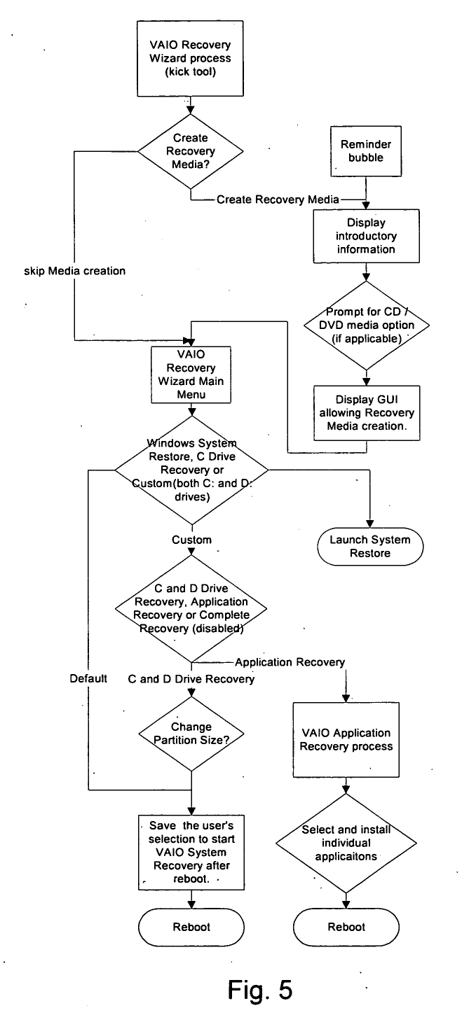

FIG. 5 illustrates basic steps in example recovery procedures that a user might take depending on different recovery conditions in a preferred embodiment.

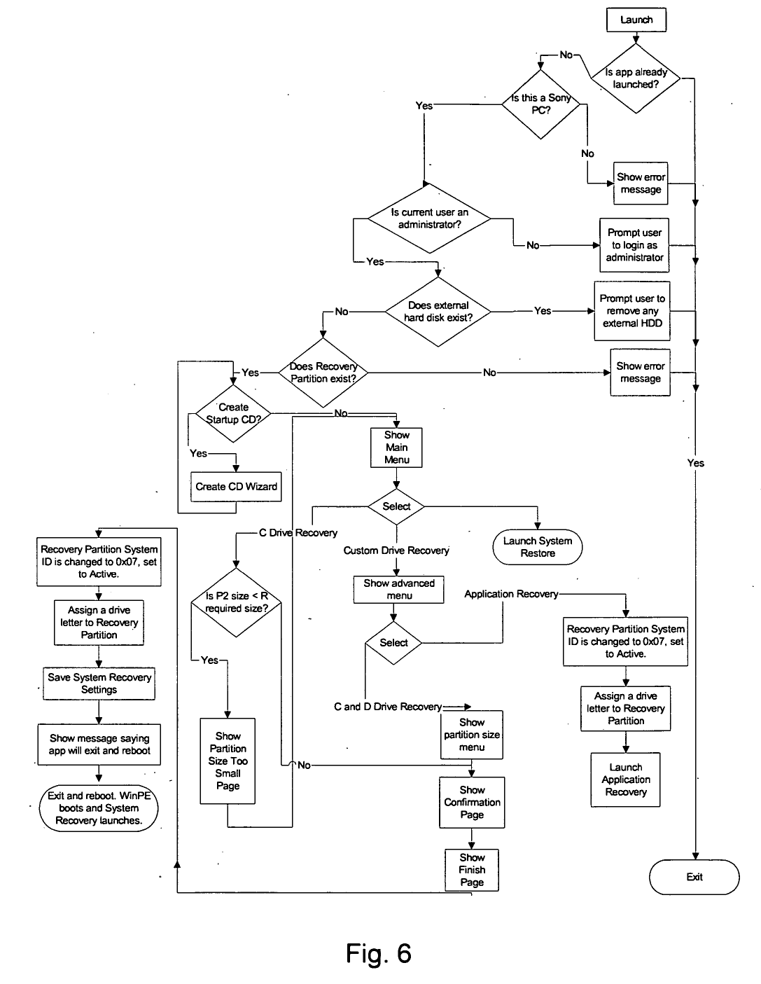

FIG. 6 illustrates basic steps in possible execution of functions in the Launcher. Details on these steps are provided in Table VIII, below.

TABLE VIII
Design Details

Is app already launched?
Checks if the application is already running.
Is this a Sony PC?
Checks for universal Sony VAIO attributes using Sony Shared Libraries.
Is current user an administrator?
Checks if the current user is an administrator.
Does external hard disk exist?
Checks if the iLink 1394 port is being used.
Does Recovery Partition exist?
Checks the System ID of the Recovery Partition using
Rstartlib. If the System ID is anything other than 0x12 the
program returns an error and quits.
Create Recovery Media?
This menu gives the user two options:
Create Recovery Media
This is the default. Selecting this option and hitting
Next will launch CreateCD. Launcher does not exit and
stays in the background.
Do not create Recovery Media
The user must select this option to continue with the
Launcher wizard.
Main Menu
The user has two options:
C Drive Recovery
Recovers the C drive only. Takes the user to the
confirmation page. Checks if P2, C, is large enough to
recover the C drive. P2 must be greater than or equal to
P1. Otherwise the Partition Size Too Small Page
displays and the program exits.
Custom System Drive Recovery
Takes the user to the Advanced Menu.
Advanced Menu
The user has three options:
C and D Drive Recovery
Recovers the C and D drives using the Full Image.
Application Recovery
Launches Application Recovery.
Complete Recovery
[disabled in Launcher]
Partition Size Menu
Similar to the Partition Menu in System Recovery this page
allows the user to select partition choices. The partition
sizes available are default, 25%, 50%, 75% and 100% of
the available HDD size minus the Recovery Partition. Each
size is rounded to the nearest 5GB. The default size is 15
GB. If the total HDD size is less than 29 GB then the
default HDD size is 10 GB.
A table shows the current HDD partition size information.
A pie chart shows a graphical representation of the
expected result.
Confirmation page
This page displays the various options chosen. It gives the
user a chance to confirm expected result.
Finish Page
Gives the user one last chance to quit before rebooting and
starting system recover. Hitting Finish will cause the
system to close all open applications, reboot and launch
System Recovery.
Save System Recovery Settings
This is for the System Recovery. System Recovery user
settings are stored in an answer file on the Recovery
Partition. This feature allows the Chrysalis Launcher to take
care of any user prompts and input so that after windows
reboots, System Recovery can just run without user
intervention.
How do the other Chrysalis programs use the answer
file?
After selecting System Recovery from Chrysalis Launcher
Windows will exit and launch System Recovery from the
hidden WinPE Recovery Partition. System Recovery tries
to load the answer file into memory. If the answer file exists
System Recovery will recover the system. Otherwise it will
prompt the user for input.
System Recovery deletes the answer file after reading the
data into memory.
Chrysalis Launcher overwrites the answer file if it still
exists on program launch.
Recovery Partition System ID is changed to 0x07, set to Active.
Uses Rstartlib library to set the System ID for Recovery
Partition to 0x07 (NTFS). This makes the partition
available to Windows. Normally all partitions are set to
0x07(NTFS) except for the hidden Recovery Partition.
When accessing the Recovery Partition the System ID for
the Recovery Partition must be set to 0x07.
Additionally when booting into WinPE to run System
Recovery the hidden Recovery Partition must be set to
Active. This is done by selecting the first HDD, selecting
the first (Recovery) partition and setting it to active.
Note that any programs such as System Recovery and
Application Recovery must set the Recovery Partition
System ID to 0x12 when they are done so that the user's
first primary partition, P2, will boot.
Assign a drive letter to Recovery Partition
Since Chrysalis Launcher is installed on the C partition and
not on the Recovery Partition it does not have inherent
access to the Recovery Partition. It must first get a drive
letter so that other functions can access the Recovery
Partition. The Answer File, CreateCD and Application
Recovery are all on the Recovery Partition.
Rstartlib library takes care of this. When the System ID of
the Recovery partition is set from 0x12 to 0x07 the next
available drive letter is assigned to Recovery Partition. To
find the drive letter for Recovery Partition Chrysalis
Launcher maps the available drive letters before and after
running rstartlib library commands. The additional drive
letter that becomes available in the second mapping is the
driver letter to Recovery Partition. This drive letter is stored
in memory so that rstartlib library does not need to repeat
the timely drive mounting procedure.
Exit and reboot. WinPE boots and System Recovery launches.
With the System ID for the Recovery Partition set to 0x07
and active the system boots into WinPE. WinPE is set up so
that it executes System Recovery after booting.

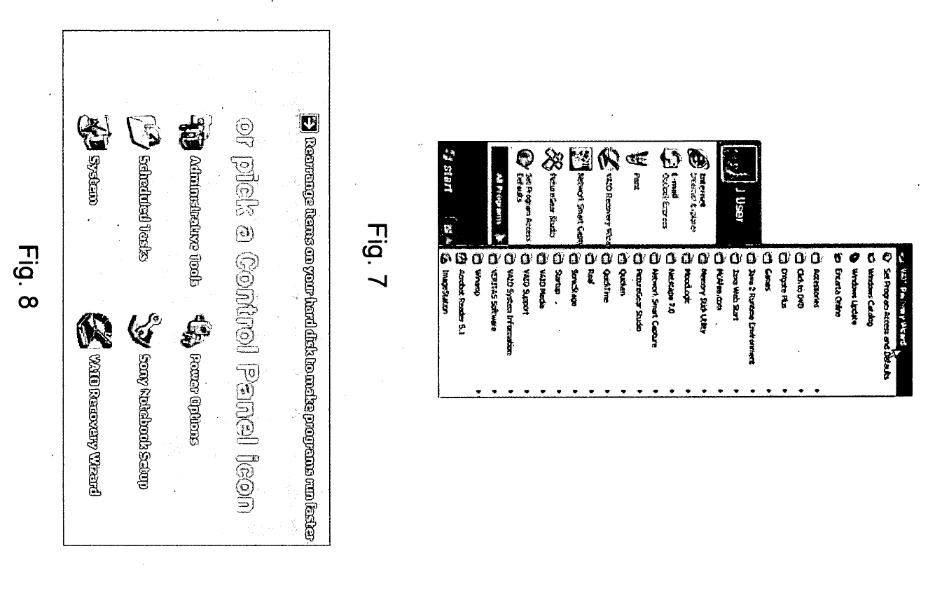

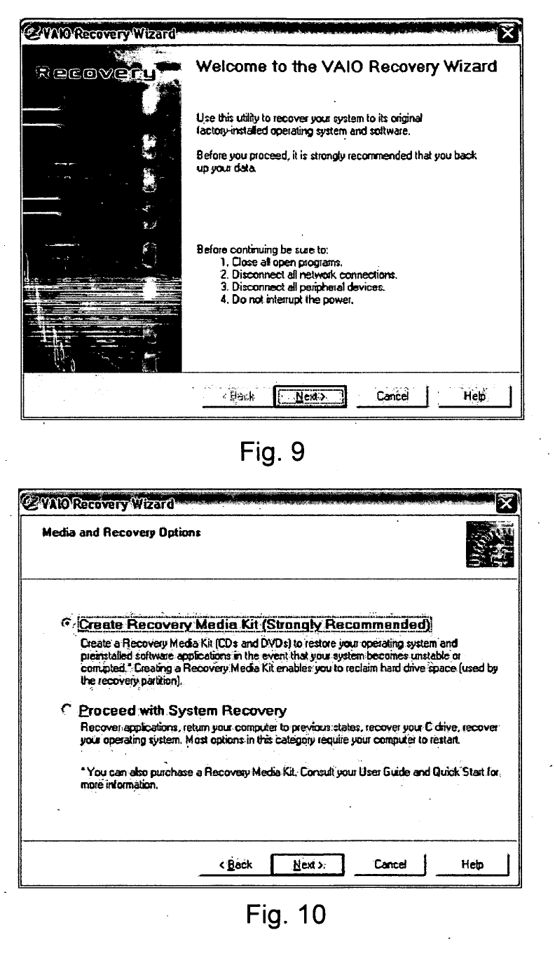

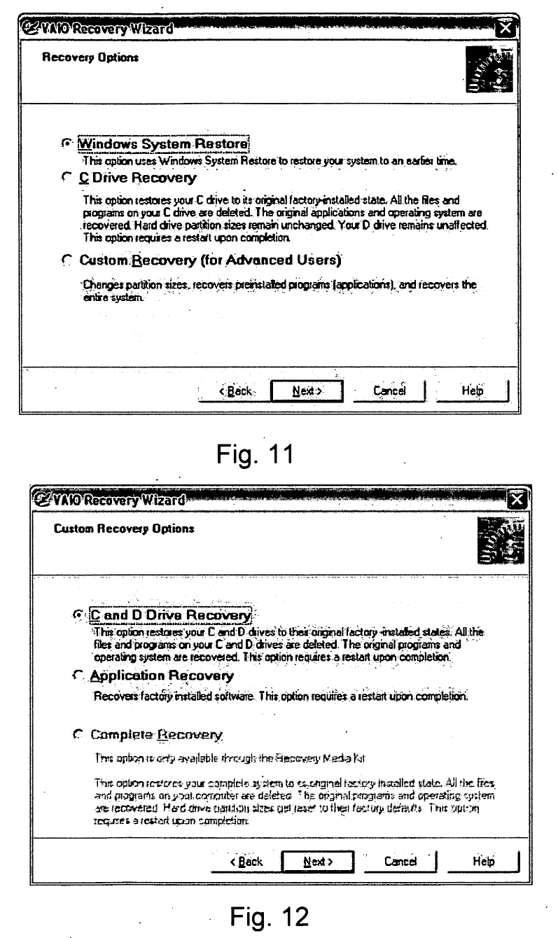

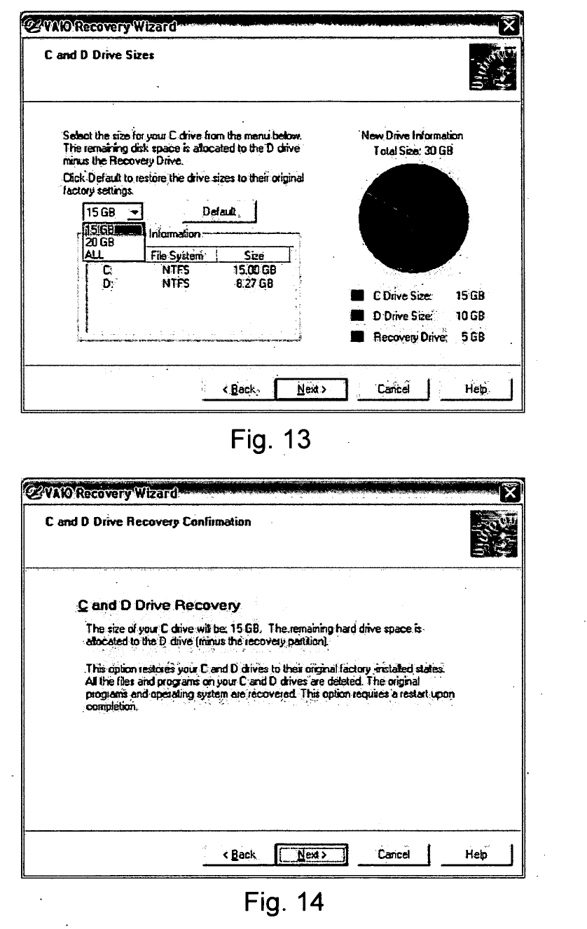

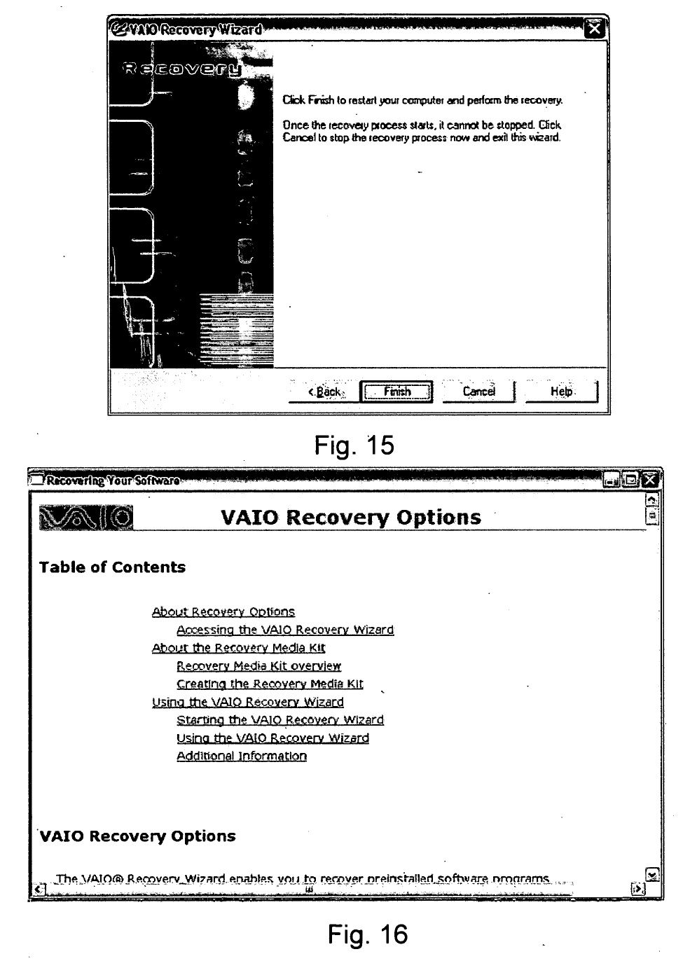

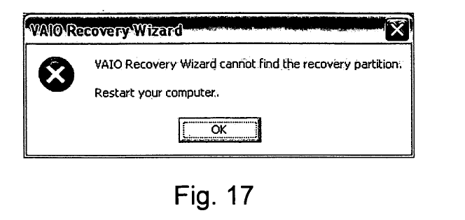

FIGS. 7-17 show example screens of the general graphical user interface of the Chrysalis tools.
FIG. 7 shows accessing the Launcher tool from Start Menu/Programs;
FIG. 8 shows accessing Launcher from the Control Panel;
FIG. 9 shows an Introduction Page;
FIG. 10 showsMedia and Recovery Options;
FIG. 11 shows a Main Menu screen;
FIG. 12 shows Custom Recovery options;
FIG. 13 shows C and D Drive Sizes;
FIG. 14 shows a Confirmation screen;
FIG. 15 shows a Finish screen;
FIG. 16 shows a Help screen; and
FIG. 17 shows an error message from Launcher when P1 is not hidden.

The CreateCD tool is used to create the recovery media, such as a recovery CDROM. CreateCD creates recovery media from the P1 contents. A listing of all files needed on each disc is included within the configuration file snyhdrcv.ini. As long as the P1 partition exists the user can create as many sets of recovery discs as needed.

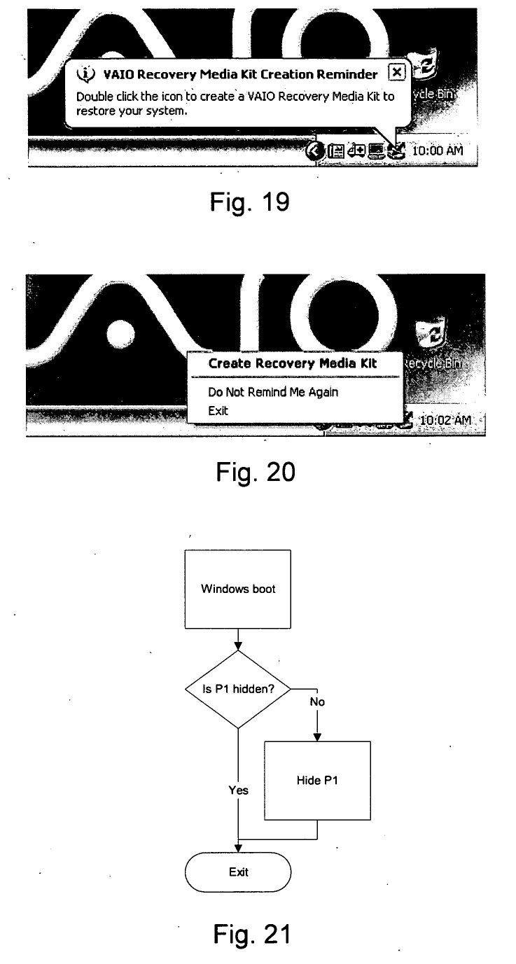

The Reminder tool is included within the image. A “reminder” is displayed as a bubble that pops up in task tray asking the user to create the recovery discs. As shown in FIG. 19, the bubble pops up in the task tray asking the user to create the recovery discs. With the task tray on the bottom of the screen the bubble will display in the bottom right corner. This bubble will display for a few seconds. The user will have to either choose to create the recovery discs or select “Do not remind me again” in the right click menu to get rid of the reminder on every Windows boot.

FIG. 20 illustrates a “right click” menu that allows the user three choices: create the recovery discs, do not remind and exit. Choosing to create the recovery discs has the same effect as double-clicking on the reminder icon in the task tray. Choosing not to remind will remove the registry settings so that Reminder will not run on every Windows boot. Note that choosing to create the recovery discs will also remove the registry settings so that Reminder will not run on every Windows boot. Choosing to exit will exit Reminder so that neither the bubble or recovery icon display from the task tray. This option will not remove the registry settings for Reminder.

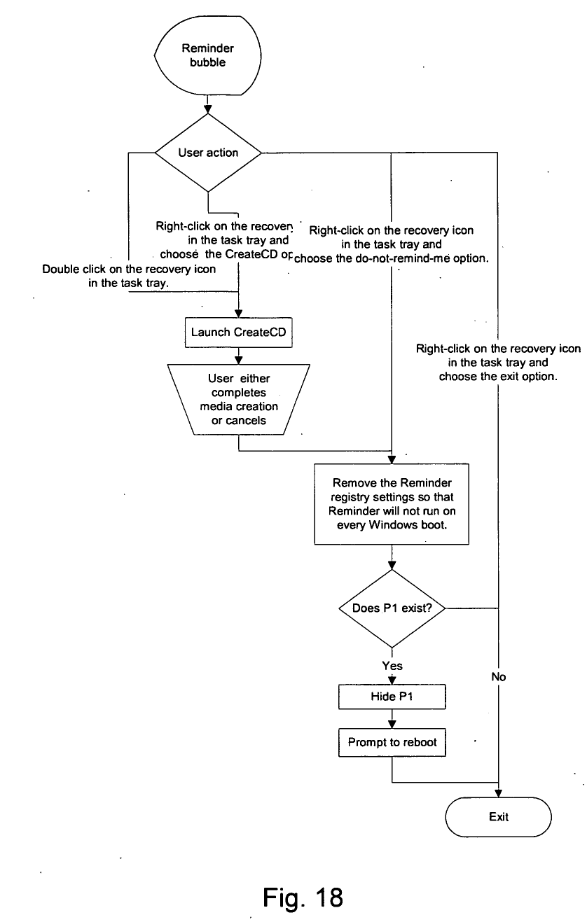

FIG. 18 shows basic steps the user can take as a result of a reminder.

In a preferred embodiment, Reminder is added to the registry Run area so that it runs on every boot. The registry key and value are
HKEY_LOCAL_MACHINE\SOFTWARE\Microsoft\Windows\CurrentVersion\Run\CreateCD_Reminder
and
C:\WINDOWS\Sonysys\VAIO Recovery\reminder.exe
respectively. This registry key is removed when the user either launches the CreateCD program from reminder or chooses the do-not-remind-me option.

The PartSeal tool is used to hide P1 on Windows boot if it is not hidden. In a preferred embodiment there is no user interaction as the process happens automatically.

FIG. 21 shows the basic processing of PartSeal. One of the concerns with HDD Recovery is the visibility of the P1 contents by any means. The data on P1 is intended for the customer. The customer will need to access this data when doing any of the steps for HDD Recovery. However, the customer should not see or have any awareness of this partition during normal operation. Normal user interaction should be the same as with a non-HDD Recovery system. The main concern with having a recovery partition is that the user does not tamper with the partition or otherwise alter the contents.

Launcher and Reminder cannot find the P1 drive letter if P1 is not hidden. Consequently none of the programs on P1 are accessible. PartSeal determines if P1 was hidden by checking with rstartlib code. Program code is not launched if P1 is not hidden. At this point it becomes crucial to hide P1 so that the HDD recovery tools are accessible. However, hiding P1 would not always work without doing a reboot first. The main reason this often does not work is that if some files on P1 are in use as when running CreateCD or Art P1 cannot be hidden. Even exploring P1 with Windows Explorer causes P1 hiding to fail. So in these cases a reboot is required every time P1 is accessed. PartSeal will hide P1 if the partition is not hidden on the next boot.

One benefit of PartSeal is that P1 is always hidden on the next boot if the HDD Recovery tools are terminated from Task Manager or otherwise exited abnormally. This ensures that any HDD Recovery operation remains transparent to the user.

In a preferred embodiment, PartSeal is added to the registry Run area so that it runs on every boot. The registry key and value are
HKEY_LOCAL_MACHINE\SOFTWARE\Microsoft\Windows\CurrentVersion\Run\VAIO Recovery
and
C:\Windows\Sonysys\VAIO Recovery\PartSeal.exe
respectively. This registry key is not removed by any of the Chrysalis tools.

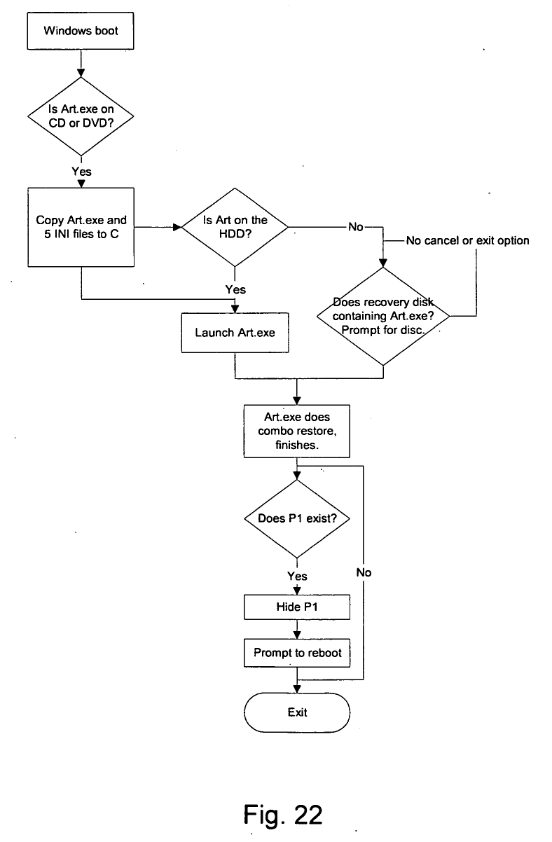

The LaunchCombo tool invokes Art to do combo restore. If applicable it hides P1 when Art is done. FIG. 22 shows the available processing. LaunchCombo does not give the user any choice. In a preferred embodiment there is no user interaction as the process happens automatically. Other embodiments can include varying levels of user selection or participation in this or other processes described herein, as desired.

The executable name is AlaunchCombo.exe instead of LaunchCombo.exe so that it will be run earlier in the list of startup programs. LaunchCombo is added to the Windows startup directory. There are several possible Windows startup directories in which case LaunchCombo is placed in the first valid startup directory. The directory
C:\Documents and Settings\All Users\Start Menu\Programs\Startup is used most commonly. The listing would be:
C:\Documents and Settings\All Users\Start Menu\Programs\Startup\AlaunchCombo.exe

When launched by LaunchCombo to do combo restore Art removes the LaunchCombo reference from the startup directory.

Autorun runs automatically from the inserted disc. Originally this program was designed to just display a pop up message telling the user which disc to insert for System Recovery. Now with the option to remove P1 the ability to run Art from discs is also important.

Launch Application Recovery (Art) is the first task Autorun tries. If this is disc 1 then Autorun copies the contents of the Art directory to C:\Windows\Sonysys\Vaio Recovery. Autorun also copies the INI files appinfo.ini, bitindex.ini, module.ini, blids.ini and snyhddrcv.ini to C:\Windows\Sonysys. Art is launched from C:\Windows\Sonysys\Vaio Recovery.

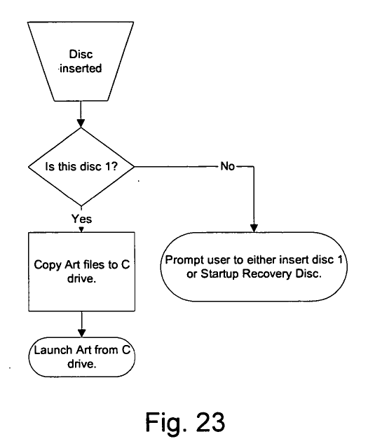

A prompt to insert Disc 1 or Startup Recovery Disc guides the user to either insert the first disc for Application Recovery or the Startup Recovery Disc for System Recovery. In a preferred embodiment, Launcher is not run from Autorun. FIG. 23 illustrates the basic steps in processing. There is no user interaction as the process happens automatically.

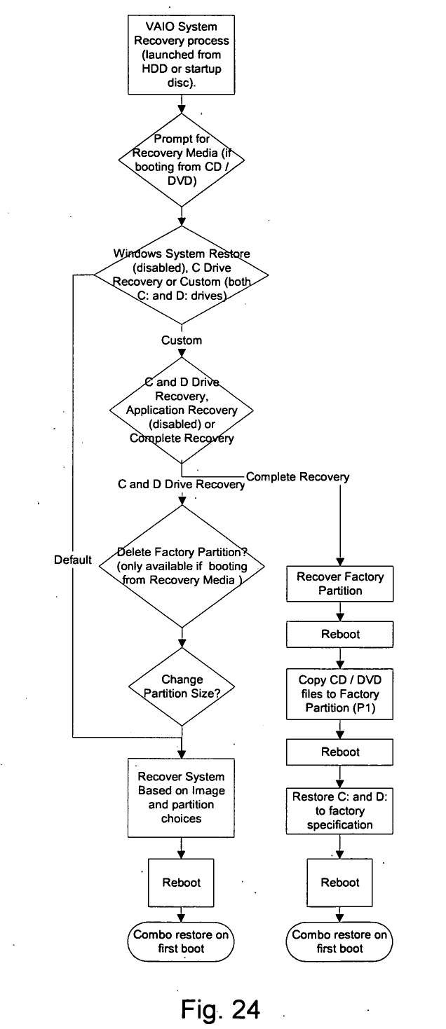

The System Recovery tool is designed to run in WinPE. Choosing System Recovery from Launcher allows the user to choose the desired type of system recovery. Launcher acts like a facade and passes the user input to System Recovery. System Recovery then takes the input and recovers system files automatically. System Recovery reads the answer file provided by Launcher to skip the user prompting within WinPE. It reads the data into memory and starts the recovery process. This skips the initial wizard and goes directly to recovery. The basic functionality of System Recovery is shown in FIG. 24.

System Recovery checks the existence of an answer file upon loading. If it exists System Recovery provides a summary of the expected outcome and asks the user permission to continue. If the answer file does not exist System Recovery starts at the beginning of the System Recovery Wizard outlined in VSRU. On Exit System Recovery sets the System ID of Recovery Partition back to 0x12.

A combo restore feature adds the program AlaunchCombo.exe to the startup so that application combo restore happens automatically on first boot. If the user has a Recovery Partition (P1) and does a HDD recovery, the modules are installed from P1. Otherwise if using discs to recover, the modules are installed from the discs.

Although the invention has been described with respect to specific embodiments thereof, these embodiments are merely illustrative, and not restrictive, of the invention. For example, although a preferred embodiment of the invention uses a single directory for data related to images and modules, other embodiments can use any number of directories, files, or other data structures or organizations. Although the invention may be discussed primarily with respect to specific media types such as optical, magnetic, solid state, etc., any type of storage media type, information source or device can be used.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

Although specific types and numbers of tools, utilities, routines or other programs and functionality has been presented, the functionality provided by embodiments of the invention can be provided by many different design approaches. For example, more or less than six tools can be used. A different ordering of functions (i.e., tool execution) may be desirable in different embodiments. Different designs can include combined functionality of several tools into one, or functions can be allocated to more than six tools. It may be possible and desirable to omit functions described herein in some embodiments. Different embodiments can include more or less automation and more or less manual intervention. Features can be added, deleted, or modified, as, for example, to accommodate future computer operating systems, applications, utilities, drivers or other components.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term \“or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for configuring a target computer system, the method comprising
creating an image of a first plurality of software components;
storing the image onto the target computer system;
determining additional software components to be stored onto the target computer system;
storing the additional software components by using a predefined module.

2. The method of claim 1, wherein a module includes at least a portion of setup information provided by a manufacturer of a first software component associated with a first module.

3. The method of claim 1, wherein a module includes at least a portion of a compressed software component.

4. The method of claim 3, wherein a module includes at least a portion of a PAC file.

5. The method of claim 1, wherein the image includes a foundation image.

6. The method of claim 1, wherein the image includes a recovery image.

7. The method of claim 1, further comprising
storing a plurality of data files, wherein a data file includes system specific configuration information.

8. The method of claim 7, wherein the data files are stored in a common directory.

9. The method of claim 7, wherein a code field is used to indicate what images can be loaded onto a particular system.

10. The method of claim 1, further comprising
creating an initialization file;
copying a recovery image to a temporary location;
restoring the recovery image to a first partition from a temporary location;
copying the recovery image from the firs partition to a temporary location;
copying a foundation image to the first partition via a network;
restoring the foundation image to a second partition;
copying permanent modules to the first partition;
copying a data file to the first partition;
copying temporary modules to the first partition;
copying a module including at least a portion of a software component to the first partition;
executing one or more modules; and
deleting modules from the first partition.

11. The method of claim 1, further comprising storing a process for recovering an initial installation.

12. An apparatus for configuring a target computer system, the apparatus comprising
a machine-readable medium including
one or more instructions for creating an image of a first plurality of software components;
one or more instructions for storing the image onto the target computer system;
one or more instructions for determining additional software components to be stored onto the target computer system; and
one or more instructions for storing the additional software components by using a predefined module.

13. A machine-readable medium including
one or more instructions for creating an image of a first plurality of software components;
one or more instructions for storing the image onto the target computer system;
one or more instructions for determining additional software components to be stored onto the target computer system; and
one or more instructions for storing the additional software components by using a predefined module.

14. An apparatus for configuring a target computer system, the apparatus comprising
means for creating an image of a first plurality of software components;
means for storing the image onto the target computer system;
means for determining additional software components to be stored onto the target computer system; and
means for storing the additional software components by using a predefined module.

15. A method for recovering software components, the method comprising
installing at least a portion of a foundation image;
selectively allowing a user to install a software component from a third-party installation medium; and
selectively allowing a user to install a software component from a secondary file.

16. The method of claim 15, wherein the secondary file includes a PAC file.
